(19) United States
(12) Patent Application Publication
(10) Pub. No.: US 2026/0212217 A1
(43) Pub. Date: Jul. 23, 2026

(54) METHOD AND SYSTEM FOR GENERATING AND QUERYING A SELF-ORGANIZING KNOWLEDGE GRAPH

(71) Applicant: Agnetic Labs Inc., San Francisco, CA (US)

(72) Inventors: David Yue, Plano, TX (US); Finsam Samson, Plano, TX (US)

(73) Assignee: Agnetic Labs Inc., San Francisco, CA (US)

(21) Appl. No.: 19/451,538

(22) Filed: Jan. 16, 2026

Related U.S. Application Data
(60) Provisional application No. 63/746,696, filed on Jan. 17, 2025.

(51) Int. Cl. G06N 5/022; G06N 5/04

(52) U.S. Cl. CPC G06N 5/022; G06N 5/04

(57) ABSTRACT

In variants, the method can include maintaining a self-organizing knowledge graph (SOKG) including a set of related entities by extracting new information from new entities and propagating the new information through the SOKG by updating the information for existing entities within the SOKG. The SOKG can be used to answer queries using SOKG entities that are implicitly or explicitly related to the query.

### CROSS-REFERENCE TO RELATED APPLICATIONS

This application claims the benefit of U.S. Provisional Application No. 63/746,696 filed 17 Jan. 2025, which is incorporated in its entirety by this reference.

### TECHNICAL FIELD

This invention relates generally to the unstructured data field, and more specifically to a new and useful system and method for navigating unstructured data in the unstructured data field.

### BRIEF DESCRIPTION OF THE DRAWINGS

FIG. 1 is a schematic representation of a variant of the method.

FIG. 2 is an illustrative example of a variant of processing a new document and using a set of AI agents to extract elements (e.g., entities, attributes, and relationships to other documents, etc.), verify extracted elements, and/or add to a Self-Organizing Knowledge Graph (SOKG).

FIG. 3 is an illustrative example of a first variant of querying the SOKG.

FIG. 4 is an illustrative example of a second variant of querying the SOKG.

FIGS. 5 and 6 are illustrative examples of connected SOKGs with a private SOKG and a public SOKG.

FIG. 7 is an illustrative example of adding a new entity to the SOKG and propagating changes from the new entity through the SOKG.

FIG. 8 is an illustrative example traversing the SOKG for related entities.

FIG. 9 is an illustrative example of generating a query response using the SOKG.

### DETAILED DESCRIPTION OF THE INVENTION

The following description of the embodiments of the invention is not intended to limit the invention to these embodiments, but rather to enable any person skilled in the art to make and use this invention.

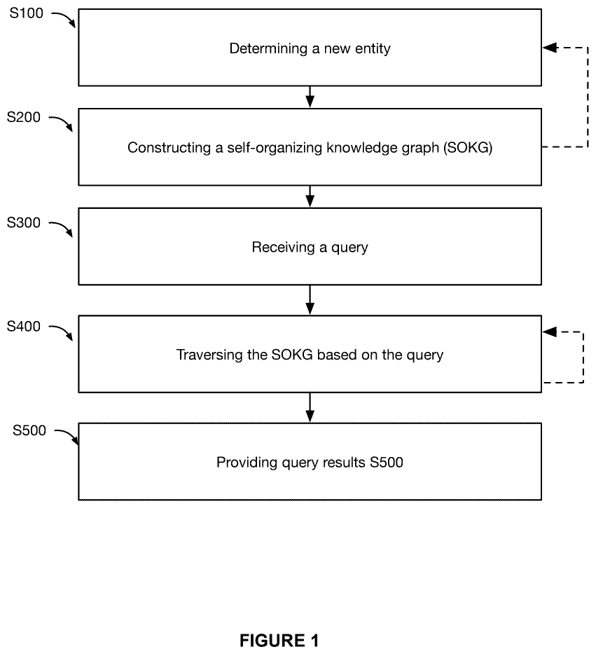

As shown in FIG. 1, variants of the method can include: determining a new entity S100; constructing a self-organizing knowledge graph (SOKG) S200; receiving a query S300; traversing the self-organizing knowledge graph based on the query S400; identifying a set of response entities S420; extracting relevant information from the identified entities S440; evaluating whether a stop condition is met S480; and providing query results S500. The method functions to extract entities, relationships, and attributes from new datum to propagate knowledge graphs and respond to user queries by identifying relevant document embeddings and relationship classifications.

In an illustrative example, the method can receive a set of documents (e.g., entities), determine relationships between each document and entities referenced within the document using an undefined schema (e.g., wherein the freeform relationships are described by an LLM), optionally update the existing entity (e.g., the precedential status, etc.) based on the new document information, optionally iteratively identify and update additional entities related to the existing entity (e.g., using an undefined schema), optionally store the entities and relationships in association with information extracted from the document, receive a query, identify initial documents of interest based on an embedding similarity between the query embedding and the respective document embeddings, iteratively identify secondary documents of interest based on the relationships between the current document and related documents until a stop condition is met (e.g., a timeout condition, a depth condition, a summary change condition, an embedding change condition, etc.), and generate a response to the query based on the identified documents of interest (e.g., using an LLM).

In variants, the secondary documents of interest can be identified by passing the freeform relationship descriptors, the related document identifiers, and optionally the query to an LLM, wherein the LLM identifies the secondary documents for subsequent analysis.

In variants, document of interest identification can be biased using a set of rules (e.g., temporal preference rules, authority preference rules, relationship class rules, etc.), which can simplify or expedite the search.

In variants, the response to the query can be generated by passing the query, the set of identified documents (e.g., the raw documents and query or embeddings thereof), the attributes extracted from the documents, the relationship descriptors, and/or other information to an ML agent, and instructing the model to generate a response.

The response can be iteratively generated (e.g., as documents are identified), or be generated after a set of documents have been aggregated.

In variants, all or portions of each method process can be performed by an AI agent within an agent set (e.g., agent network).

Different agents within the agent set can share the same underlying base ML model, but be finetuned, instructed, or otherwise primed for the respective task. In examples, the relationship classifications and attributes can be determined without reference to a predetermined ontology, such that the relationship classifications and attributes are generated by the AI agent. In an example, if IRC Section 179A is updated regarding electric vehicle tax credits in California, the agents would extract entities (IRC 179A), geography (California), and industry (automotive). An agent then autonomously identifies relationships between this new code and existing documents in the knowledge graph (e.g., other automotive-related IRC sections or state and local statutes, etc.), creating links and updating metadata where needed. If the new code overrules previous interpretations, those relationships are automatically captured.

A tax professional can query the resultant SOKG, wherein the query would trigger a similarity search using these key terms, then traverse the graph beginning with the most recent documents, following relationships to gather context about IRC 179A and related provisions.

The system recursively explores connected nodes while synthesizing information until it has sufficient context to provide an up-to-date, accurate answer incorporating both the new code and any related interpretations or rulings.

Variants of the technology can confer one or more advantages over conventional technologies.

First, variants of the technology resolve recency challenges suffered by conventional large machine learning models. Large machine learning models conventionally suffer from static knowledge-they are limited to the information available within their training data sets (e.g., their parametric data) and are unaware of any information available post-training. This means that any response provided by the large ML model is almost always outdated. Variants of the technology can enable large ML models to access recent data by dynamically updating a knowledge graph with up-to-date information and then having the large ML model traverse the knowledge graph to respond to queries.

Second, variants of the technology can enable large corpora of nuanced interconnected knowledge, such as tax, accounting, and/or legal knowledge, to be rapidly traversed in real or near real-time. In variants, the technology can generate a knowledge graph using key attributes extracted from each document, such as identified entities and the document's treatment of those entities. This can reduce the amount of information that needs to be traversed to identify the controlling documents to use in generating the query response. In variants, the technology can iteratively retrieve and summarize entity data when generating the query response. The iterative retrieval enables the model analyses to be limited to a smaller corpus of highly-relevant information, which allows the technology to accommodate the models'limited context windows. Furthermore, in variants, the technology can analyze the extracted information (e.g., document summaries, individual sections, attribute values, relationship values, etc.) in lieu of the full document texts. This can better focus the models on high-lift information, and can additionally accommodate the models'limited context windows.

Third, variants of the technology can enable more nuanced knowledge graphs to be built with less maintenance and more nuance by using a flexible schema. By not restricting the AI agents to a specific schema or ontology when instructing the AI agents to extract attribute values of each entity (e.g., document), this method enables more nuanced attributes (e.g., inter-document relationships) to be automatically generated by the large ML model. For example, instead of simply identifying that a Supreme Court holding invalidated a statute, the relationship descriptor between the Supreme Court holding and the statute can include the treatment in addition to dissents and/or reasoning (e.g., “invalidated by a slim majority”). While this can make retrieval for query response more difficult, since strict rules can no longer be applied due to the high variance in attribute values, it can make retrieval and/or response generation more accurate, since more information is used when evaluating whether a document is relevant to the request. This can also enable emergent attribute and relationship detection (e.g., enables identification of relationships and attributes that humans would not have otherwise identified).

Fourth, variants of the technology enable use of an agentic librarian to coordinate and control the set of agents that build and query the SOKG.

Fifth, variants of this technology can solve the unstructured retrieval challenge by using large models (e.g., LLMs) to interpret a given document's attributes and relationships, to determine whether the document is relevant to a query. This can leverage the probabilistic nature of large models to interpret different representations of similar concepts similarly to identify the relevant documents.

Sixth, variants of the technology can additionally implement a verifier that verifies whether the returned relationship is described in the document. The verifier can mitigate the effects of LLM hallucinations and/or artifacts caused by the probabilistic nature of LLMs.

However, further advantages can be provided by the system and method disclosed herein.

All or portions of the method can be performed every time a new entity is received, when updates to legal cases are detected, when relationship between entities changes, when case information changes, when a new statute, regulation, administrative ruling, or agency guidance document is published, when an external data source or feed indicates that metadata, effective dates, or status of an existing authority has changed, when a user or automated workflow requests an audit, briefing, or refresh of a watch listed entity or topic, when a number or rate of detected changes exceeds a threshold (e.g., a threshold number of updated entities within a time window), when the system detects a conflict or inconsistency between attributes, embeddings, or relationships for an entity, on a scheduled basis (e.g., daily, weekly, at the end of a reporting or tax period, etc.), and/or any other suitable conditions or triggers. The method can be repeated for every new query, for every new datum, for every update detected, and/or any other suitable trigger for repetition.

The method is preferably used with a set of self-organizing knowledge graphs (SOKGs), but can additionally or alternatively be used with a single SOKG.

The SOKGs can store entity information and optionally inter-entity relationships. The inter-entity relationships are preferably determined by a generative model (e.g., LLM), without reference to a predetermined or human-specified schema or ontology, but can alternatively be manually specified, determined based on a human-defined schema or ontology, or otherwise determined.

The self-organizing knowledge graph (SOKG) is preferably an implicit graph, but can alternatively be an explicit graph, and/or any other suitable graph type. The self-organizing knowledge graph (SOKG) is preferably an unstructured graph, wherein entities are associated with relationships with other entities but lacks a strict structure (e.g., the relationships are stored as attributes for the entity), but can alternatively be a semi-structured graph, structured graph (e.g., with a strict graph structure), and/or any other suitable graph structure. The self-organizing knowledge graph (SOKG) can be stored in a document-oriented database, but can alternatively be stored in a graph database, and/or any other suitable database type. The self-organizing knowledge graph (SOKG) is preferably directional, but can alternatively be undirected.

The relationships stored by an entity are preferably unidirectional (e.g., describing how the entity is related to the second entity), but can alternatively be bidirectional (e.g., describes how each entity relates to each other), and/or any other suitable relationship type. The self-organizing knowledge graph (SOKG) is preferably acyclic, but can alternatively be cyclical, and/or any other suitable graph structure. The set of relationships associated with an entity can be prioritized or unprioritized. In an example, the set of edges can be prioritized by time, relationship classification (e.g., overturned is first priority, negative treatment is second priority, possible negative treatment is third priority, upheld is fourth priority), and/or by any other suitable parameters.

In a first variant, the self-organizing knowledge graph (SOKG) can be an implicit graph, wherein an agent (e.g., LLM) infers each related entity and the nature of the relationship (e.g., describes the relationship using an unstructured schema). The graph is formed from references to related entities (e.g., wherein the related entity can be looked up based on the name instead of looking up an explicit node or following a pointer, etc.), but can be otherwise formed. For example, the graph can be an unstructured library of entities. Relationships can be identified between an entity and a set of secondary entities based on context, inferred links, structural patterns found within the entity, and/or any other suitable identification methods. The relationships can be determined without reference to a strict schema or a set of predetermined relationship classes. The entities can be determined without reference to a strict set of identifiers. In examples, the relationships can be stored as attributes (e.g., “repealed § 13516 of the Tax Cuts and Jobs Act”, “negative treatment of § 13516 of the Tax Cuts and Jobs Act”, etc.) associated with the entity. In examples, the agent can detect informal, unstructured, or freeform relationships (e.g., references, text description of similar language between cases, contextual/shared tags, etc.), without reference to a strict schema.

In a second variant, the self-organizing knowledge graph (SOKG) can be an explicit graph, with explicit nodes (e.g., entities) and edges (e.g., relationships between the entities). The relationships preferably conform to a strict schema, but can alternatively be associated with a relationship classification, a predetermined relationship type, and/or any other suitable relationship format. The relationships can be stored according to a strict data structure. In an example, a relationship can be stored as “relationship: repealed, entity: § 13516 of the Tax Cuts and Jobs Act”. The entity identifiers can be determined based on a set of rules (e.g., ABA citations, bluebook citations, etc.), determined freeform (e.g., without reference to a predetermined schema or set of rules), and/or any otherwise determined.

However, the self-organizing knowledge graph (SOKG) can be otherwise structured.

In a first variant, a SOKG can include a logical graph structure that can include a node set and an edge set. The node set can be an explicit node or an implicit node (e.g., a document record). Each node is associated with an entity identifier (e.g., a document identifier, citation, docket number, etc.), an entity attribute set (e.g., metadata, tags, facets, extracted entities, jurisdictions, topics, and/or other attributes, etc.), one or more semantic representations (e.g., full text, summaries, sections, etc.), one or more embeddings or feature vectors representing the entity in a latent space, one or more status signals (e.g., validity, authority, risk, or other derived states), and/or any other associations.

Each edge can represent a relationship between a pair of entities can be an explicit edge (e.g., a stored relationship, a stored reference to another entity with a set of edge labels, etc.) or an implicit edge (e.g., shared information values). Each edge can be associated with: an edge type or relationship classification (e.g., treatment type, lifecycle event, dependency, structural or contextual relationship, etc.), optional weights or scores (e.g., confidence, strength, frequency, priority, etc.), optional reasoning or justification describing why the relationship exists or how it was inferred, and/or any other associations.

Different SOKGs can be differentiated based on the underlying knowledge corpus (e.g., tax corpus, accounting corpus, legal corpus, etc.), tenant or organization (e.g., a separate private SOKG per firm, company, or client, etc.), jurisdiction or domain (e.g., federal tax SOKG vs. state tax SOKG, or US corpus versus EU corpus, etc.), environment or lifecycle stage (for example, staging versus production, experimental versus validated, etc.), and/or any other suitable partitioning or scoping dimension.

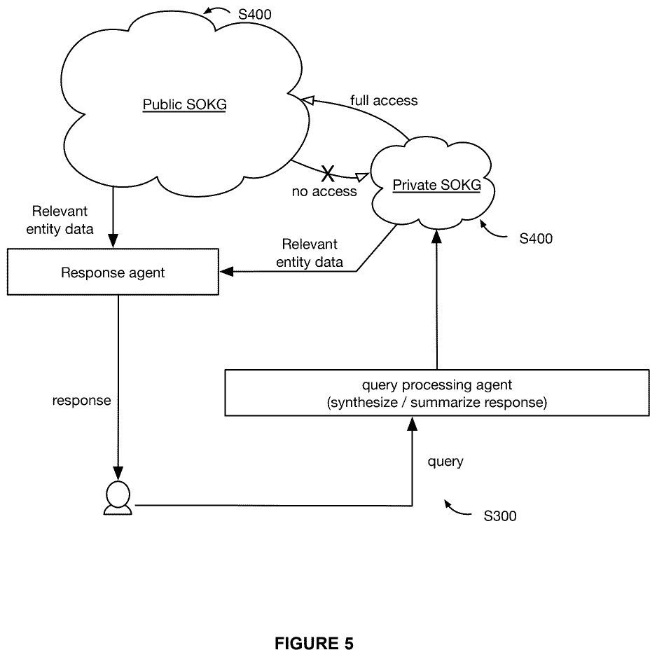

When multiple SOKGs are used, the SOKGs can include connected SOKGs and/or disconnected SOKGs. In a first example, connected SOKGs can include entities in a first SOKG referencing entities in a second SOKG through cross-graph relationships (e.g., example shown in FIG. 6) and/or a private memo node in a private SOKG referencing a public authority node in a public SOKG (e.g., example shown in FIG. 5). In a second example, connected SOKGs can include shared identifiers and/or attribute mappings (e.g., shared citations, code sections, docket numbers, embeddings, etc.). In a third example, entities, relationships, and/or metadata of one disconnected SOKG are logically and/or physically isolated from other SOKGs. In a fourth example, no cross-graph edges and/or shared identifiers that are exposed to traversal agents operating on a given disconnected SOKG. In a fifth example, queries that are evaluated against the disconnected SOKG and/or subset of SOKGs selected for the relevant tenant, user, and/or use case.

The system can include a public SOKG formed from publicly available authorities (e.g., statutes, regulations, rulings, cases, guidance, etc.), one or more private SOKGs formed from tenant-specific or internal corpora (e.g., internal memos, work product, client returns, internal policies, etc.), and/or any other SOKG configuration, wherein public SOKG entities are traversable by multiple tenants, each private SOKG is accessible only to its associated tenant, cross-graph links are optionally allowed from private SOKGs to the public SOKG while links from the public SOKG into private SOKGs are restricted or disallowed to preserve isolation, and/or any other configuration. In a specific example, a global public SOKG represents tax codes, regulations, and/or public rulings, while separate private SOKGs represent firm-specific or client-specific know-how.

The SOKG can store a set of entity information (e.g., node information) for each entity. The entity information is preferably natural language, but can additionally or alternatively be quantitative (e.g., numeric; continuous, binary, discrete, etc.), a symbolic language (e.g., code), a logical language, as a set of embeddings (e.g., in a learned latent space), and/or any other suitable format.

The entity information is preferably extracted using ontology-free extraction (e.g., without human-defined meanings, concepts, relationships, and semantics), wherein the extraction defines the ontology (e.g., implicitly or explicitly), but can alternatively be entirely or partially extracted using a predefined ontology.

The entity information is preferably extracted using schema-free extraction (e.g., without a human-defined schema for the information types and/or information values that can be used), but can alternatively be entirely or partially extracted using schema-based extraction (e.g., using a human-defined schema). In an example, information can be extracted using a predefined structure (e.g., field name: field value), but the field names and field values can remain undefined, wherein the extraction model freely determines the field names and field values, but adheres to the overall predefined structure. Alternatively, the information can be extracted without a predefined structure (e.g., wherein the extraction model extracts free text).

The SOKG can include attributes, semantics, references to other entities, relationships, embeddings or feature vectors, histories thereof, and/or any other piece of information.

The attributes (e.g., metadata) are preferably emergent (e.g., autonomously identified by the agents, not human-defined), but can alternatively include or be fully steered (e.g., manually-specified). The attributes can include tags, features, facets, entities (e.g., cases, individuals names, company names, judges, tax codes, etc.), industry sectors, geolocations, authors (e.g., presiding judge), jurisdictions, topics, time (e.g., timeframes, timestamps, etc.), and/or any other attribute.

The semantics (e.g., content) can include full text of the document (e.g., the SOKG can track different versions of the same document, maintain an updated version of the document, maintain a history of changes of the document, etc.), a summary of the document (e.g., predicted by the LLM, etc.), and/or any other semantic content.

The references to other entities can include entity identifiers (e.g., case names, document names, legal section names, etc.), descriptions of the other entities (e.g., “controlling case law on commercial real estate loans in San Francisco”, wherein the referenced entity can be updated as the case law changes), and/or any other reference to other entities.

The relationships can be determined from the semantics, references to other entities, attribute values, other relationship values (e.g., relationship statuses), and/or other information. The relationships can be determined from how the entity's content treats the referenced entity and/or determined based on shared or similar attribute values (e.g., similar judge, similar fact pattern, similar argument style, etc.).

The relationships can include existence and lifecycle states, precedential status, binding status relationships, negative treatment relationships, positive treatment relationships, neutral/referential relationships, structural/contextual relationships, dependency and lineage relationships, aggregation and interaction relationships, status signals, validity, authority, scope, reliance, and/or any other relationship.

The existence and lifecycle states (e.g., what has happened to the entity over time; describe temporal validity, not interpretation) can include created/issued, amended, superseded, withdrawn, vacated, reinstated, repealed, expired, still good/active, and/or partially in force.

The binding status relationships (e.g., hierarchical authority effects; change legal force, authority relationships) can include overruled, overruled in part, abrogated, superseded by statute, vacated by higher authority, binding precedent, persuasive authority, controlling authority, reversed, affirmed, and/or modified.

The negative treatment relationships (e.g., credibility-reducing) can include questioned, criticized, limited, distinguished, disapproved, declined to follow, rejected, and/or undermined.

The positive treatment relationships (e.g., credibility-strengthening; increase precedential weight) can include followed, applied, adopted, approved, affirmed, relied upon, and/or extended.

The neutral/referential relationships (e.g., no judgment on validity) can include cited, discussed, explained, described, referenced, summarized, and/or quoted. The structural/contextual relationships (e.g., how it fits into reasoning; affects scope of relationship) can include analogized, distinguished on facts, distinguished on law, compared, contrasted, used as example, used for background, and/or used as precedent.

The dependency and lineage relationships (e.g., how one item depends on another) can include based on, derived from, implementing, interpreting, construing, clarifying, and/or building upon.

The aggregation and interaction relationships can include consolidated with, split from, merged into, part of, in conflict with, resolved by, and/or harmonized with.

The status signals (e.g., meta classifications; can be predicted from one or more related entities and their respective information) can include good law/statute/rule, bad law/statute/rule, warning/caution, neutral, pending review, treatment mixed, and/or a precedential status for each entity, indicating whether the entity is currently treated as controlling, persuasive, overruled, affirmed, questioned, or in any other status used by the system.

The validity (e.g., whether the entity's legal rule is still in force) can include valid, invalid, partially invalid, and/or other validity value. The validity can be determined based on binding status relationships, status signals, etc. The validity can be for a section of the entity, the entity as a whole, or any other portion of the entity. The embeddings or feature vectors (e.g., extracted by an encoder) and the histories thereof (e.g., version history, change history, etc.) can additionally and/or alternatively be included in the SOKG.

Each piece of information can optionally be associated with reasoning for the information value (e.g., example shown in FIG. 6). The reasoning can be automatically generated (e.g., by the LLM), generated by tracing the decision-making path, and/or otherwise determined. In an example, the reasoning can include: the chain of thought used by the extraction model to arrive at the information value; a summary of the chain of thought; a justification for the information value; citations to supporting sections of the entity; and/or any other suitable explanation. The reasoning can be used to propagate information updates to related entities, generate a query response (e.g., wherein the reasoning is passed to the response model in addition to the information value), and/or otherwise be used. In an example, the reasoning can be used as an explicit input to a propagation agent configured to predict updated information values for related entities based at least in part on the information values and the associated reasoning. Generating the query response can include passing the relationship state and the associated natural-language reason statements to a query-response agent so that the explanation for a precedential status can be surfaced to the user. In an example, the reasoning can be used as an explicit input to a query-response agent configured to predict answers to queries based at least in part on the information values and the associated reasoning.

In an example, the relationship state stored for a relationship between two entities includes not only a relationship classification but also a natural language reason statement describing the basis for the relationship state (e.g., an explanation of why one case is treated as overruling or affirming another).

Each piece of information can additionally or alternatively include a history of changes to the entity information. In an example, the history can include a timeseries of relationship changes, attribute value changes, and/or any other changes. The change can be associated with: a timestamp, the change, a summary of the change, a reason for the change, the source entity that caused the change, and/or any other information.

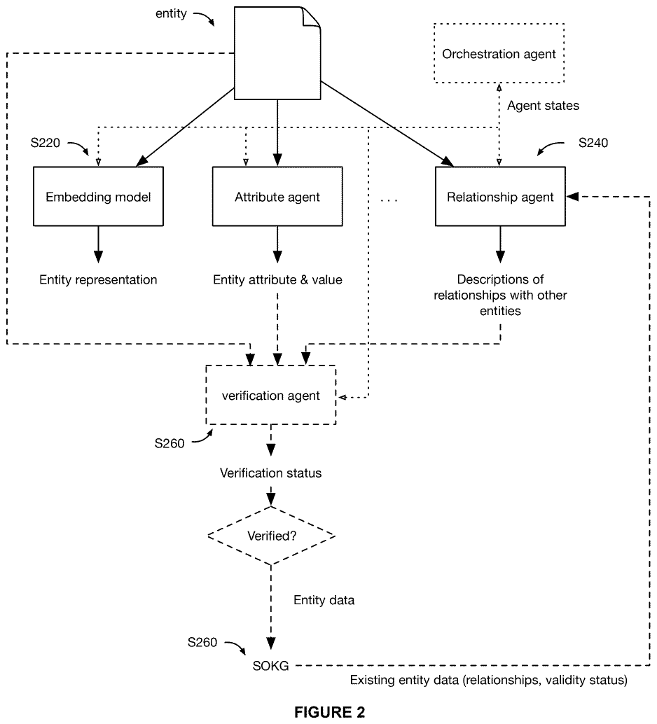

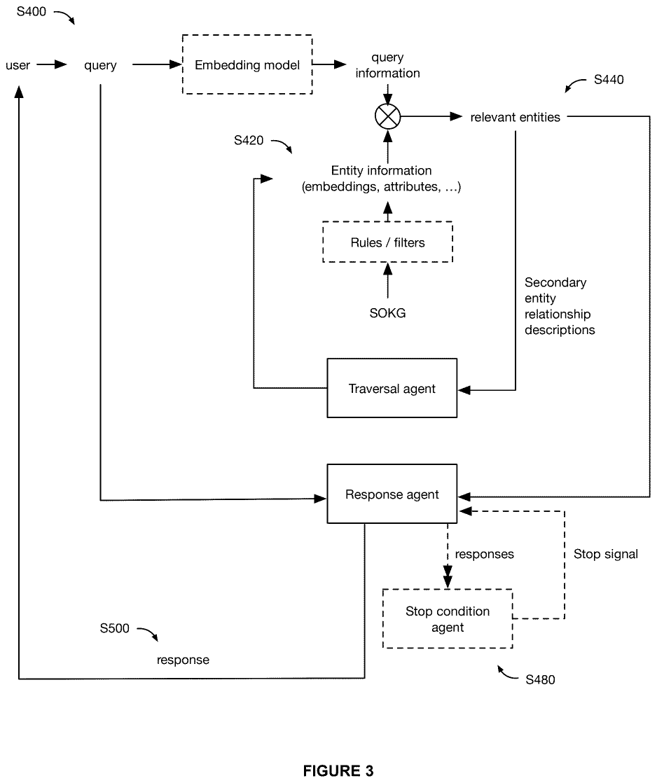

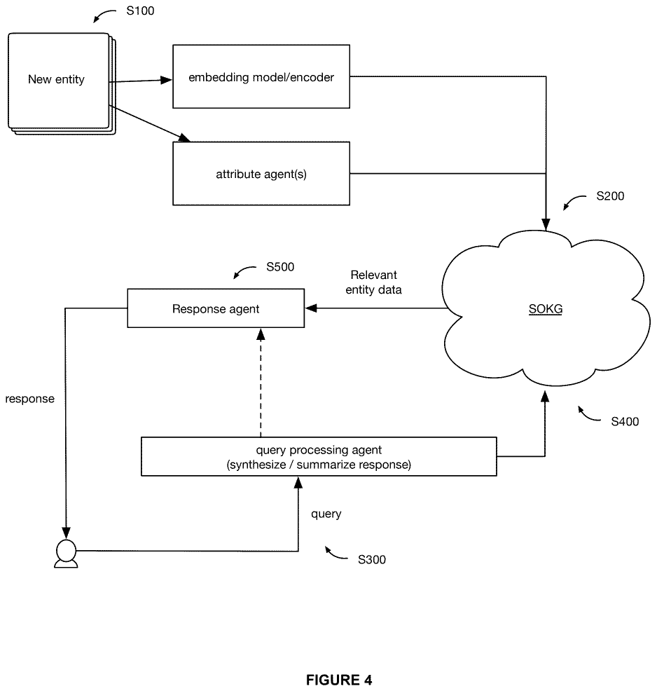

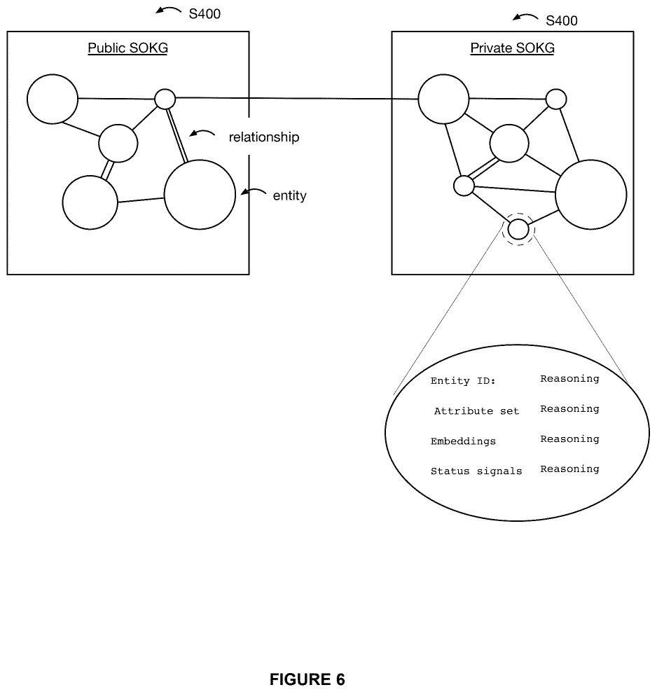

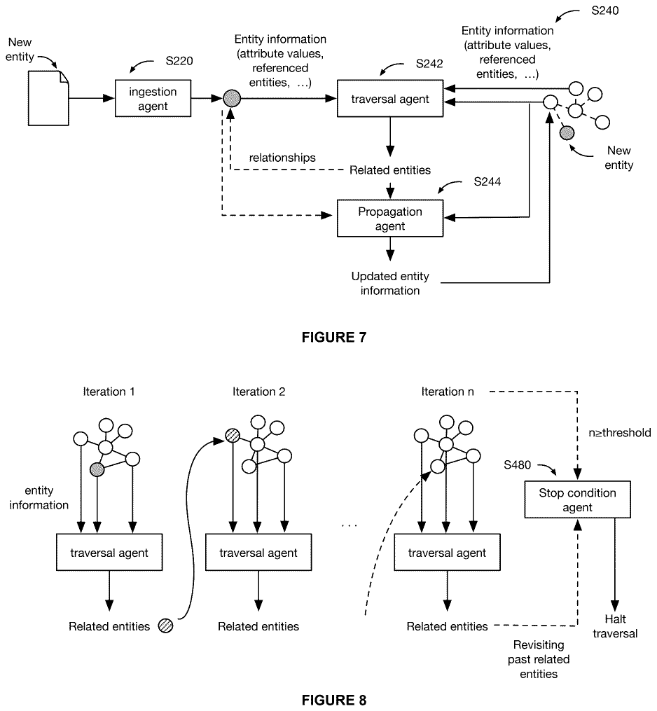

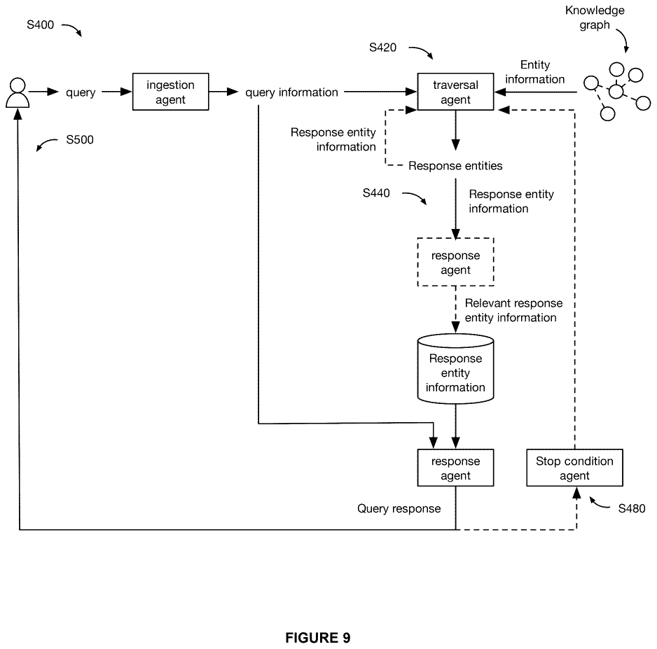

The method is preferably performed by a set of agents, but can additionally or alternatively be performed by a set of models, and/or any other suitable performers. Examples are shown in FIG. 2, FIG. 3, FIG. 4, FIG. 5, FIG. 7, FIG. 8, and FIG. 9. The system can include one or more versions of each type of agent. The set of agents can include one or more of: an orchestration agent, an ingestion agent, a relationship agent or propagation agent, a query agent, a traversal agent, a verifier agent, tool modules, and/or any other suitable agent.

The orchestration agent can function to coordinate complex workflows by calling other lower-level agents in response to triggers (e.g., ingestion of a new entity, receipt of a query, or detection of a conflict, etc.). The inputs for the orchestration agent can include a task description, the current SOKG or a summary thereof, configuration or policy rules, and/or any other suitable input. The task description can include ingesting a new statute, updating related entities, answering user queries, and/or any other suitable task description. The outputs generated by the orchestration agent can include tool calls or agent calls (e.g., instructions to invoke an entity recognition agent, propagation agent, traversal agent, and/or verifier agent), intermediate plans (e.g., a sequence of sub-tasks), control signals indicating when traversal or propagation should stop, and/or any other suitable output. The orchestration agent can be implemented as an instance of a large language model or other ML model that is primed or instructed and/or optionally fine-tuned to select and/or parameterize calls to other agents and/or tools, and/or can be otherwise implemented.

The ingestion agent can function to ingest new entities (e.g., statutes, rulings, memos, returns, etc.) and extract entity identifiers, attributes, embeddings, and/or referenced entities. The inputs for ingestion or entity recognition agent can include raw entity content (e.g., text, PDF, structured data, etc), optional metadata from the source system (e.g., source, jurisdiction, date, etc), optional schema hints, and/or any other suitable input. The outputs generated by ingestion or entity recognition agent can include entity identifier, entity attribute set, entity embedding set, an initial set of relationship candidates (e.g., cited authorities, referenced provisions, etc.), and/or any other suitable output. The entity recognition agent can be implemented as one or more models that share a common underlying architecture or are separately trained. The models can include an embedding encoder, an LLM (e.g., for attribute extraction), NER models, classifiers, and/or any other suitable model.

The relationship agent or propagation agent can function to determine relationship classifications between entities (e.g., overruled, followed, questioned, cited) and propagate updated information (e.g., validity or status values) to related entities in the SOKG. The relationship agent or propagation agent can receive a new entity (e.g., document) and determine, based on the content of the new entity, the relationship state descriptive of one or more relationships between the new entity and existing entities in the SOKG. The determined relationship can be stored in the new entity, existing entity, not stored (e.g., determined de novo each time the SOKG is traversed), and/or otherwise managed. The relationship or propagation agent can determine updated information values such as precedential statuses for existing entities based on relationship state and to propagate such updates to further entities along sequences of relationships. The relationship or propagation agent can be a single agent or include one or more subagents (e.g., a relationship agent that determines relationships, a propagation agent that updates entity information, etc.). The inputs to the relationship or propagation agent can include new or updated entity information (e.g., attributes, relationship descriptors, status signals), existing SOKG context (e.g., chains of relationships between entities, prior validity values, confidence scores), optional reasoning associated with information values, and/or any other suitable input. The outputs of the relationship or propagation agent can include updated relationship records (e.g., edge types, weights, and reasoning), updated information values for pre-existing entities (e.g., updated validity, authority, or warning status), which can be written back to the SOKG. The relationship or propagation agent can be implemented as an LLM-based propagation model, a rules engine, or a combination thereof. In examples, a propagation model is prompted or trained to predict updated information values based at least in part on relationship chains and/or stored reasoning.

The query agent (e.g., query response agent, response agent, query processing agent, etc.) can function to parse and normalize user or system queries, extract query attributes, decide which retrieval strategies to invoke (e.g., keyword search, attribute filters, embedding search, or combinations), generate a response, and/or otherwise manage a query. The inputs to the query agent can include a query (e.g., natural-language question, structured parameters, or uploaded document), optional user context (e.g., tenant, role, jurisdiction preferences), optional SOKG ontology or schema summaries, and/or any other suitable input. The outputs of the query agent can include a normalized query representation, a query attribute set, one or more retrieval plans, initial candidate entity sets, and/or any other suitable output. The query agent can be implemented as a language model instance specialized via prompting, few-shot examples, light fine-tuning to map queries into retrieval plans and attribute sets, and/or any other suitable implementation.

The traversal agent can function to autonomously traverse the SOKG by deciding which entities and relationships to follow, how deep to traverse, and when to stop traversal for a given query. The traversal agent can be configured to traverse both the public SOKG and a selected private SOKG when answering a query for that tenant, respect access-control rules so that private SOKGs for different tenants are not cross-traversed, optionally treat cross-SOKG edges as additional context when propagating validity or other status signals within a given SOKG, and/or be otherwise configured. The inputs to the traversal agent can include query representation and query attributes, current frontier of entities (e.g., candidate nodes and their relationship descriptors), SOKG metadata (e.g., validity, authority, recency), and/or traversal history. The outputs generated by the traversal agent can include an ordered set of visited entities, selected neighboring entities for subsequent hops, and updated traversal state (e.g., depth, elapsed time, summary convergence metrics). The traversal agent can be implemented as a language model or other ML model that, given the query and local neighborhood context, predicts which neighbors to explore next. In variants, the traversal agent can call similarity-scoring sub-agents and apply rule-based filters.

The verifier agent can function to act as a quality gate that verifies proposed attributes, relationships, or retrieved context against the underlying entity content and resolves or flags conflicts. The inputs to the verifier agent can include candidate extracted information values, source entity text or sections, prior values and confidence scores, optional reasoning used to support the candidate value, and/or any other suitable input. The outputs generated by the verifier agent can include verification decisions (e.g., accept, reject, or flag for review), adjusted confidence scores, and optional corrected values or explanations. In examples, verified values are written into the SOKG and rejected values are discarded or queued for re-extraction. The verifier agent can be implemented as a separate language model instance or as the same base model with different prompts, optionally augmented with rule-based checks or statistical thresholds.

The tool modules can function to perform deterministic or domain-specific operations that do not require a general-purpose language model (e.g., specialized spreadsheet or table reasoning, date arithmetic, currency or tax-year normalization, or jurisdictional filters, etc.). The inputs to the tool modules can include structured parameters from other agents (e.g., a table range, filter predicates, numeric thresholds) and optional context (e.g., tax year, jurisdiction). The outputs generated by the tool modules can include structured results (e.g., filtered rows, computed metrics, normalized values) that can be consumed by other agents such as the propagation agent, traversal agent, or query-response agent, and/or any other suitable output. The tool modules can be implemented as non-LLM modules such as domain-specific languages, rule engines, compiled functions, or external services, and/or other non-neural network modules; alternatively, can include one or more neural network models (e.g., classifiers, LLMs, generative models, etc.).

Additionally or alternatively, agents that can be used include an entity recognition agent (e.g., that identifies entities referenced within a document), relationship extracting agent (e.g., extracts relationships of entities, describes a relationship between entities, etc.), embedding agent (e.g., that generates vector embeddings for each entity and relationship), graph update agent (e.g., that updates existing entities metadata based on attributes of new entity, validates relevance and establishes a relationship between new and existing entities, etc.), query processing agent (e.g., that receives and parses the user query), a UI agent, and/or any other suitable agents.

The agents can all share the same model architecture (e.g., be different instances of the same model), or can use different model architectures. The agents are preferably different instances of the same underlying model, but can alternatively have different model architectures.

One or more of the models can include: embedding models (e.g., encoders, etc.), Named Entity Recognition (NER) models, classifiers (e.g., that classify the document or section thereof with one or more predetermined classes, etc.), and/or any other suitable model architecture. In a first example, all or a subset of the agents can share a common underlying base model (e.g., the same large language model), and be distinguished by their prompts, system instructions, or lightweight fine-tuning. In a second example, different agents can use different model architectures that communicate via structured messages or APIs under control of the orchestration agent.

Different agents can be finetuned, primed, prompted, trained, conditioned (e.g., using examples, etc.), and/or otherwise specialized for their respective task, or be untrained, not finetuned, and/or otherwise unmodified from the base model. Alternatively, different agents can be the same model, but prompted with task-specific prompts. For example, the agents are preferably not finetuned, but can alternatively be finetuned, trained, or otherwise customized. The agents are preferably primed or conditioned (e.g., with few-shot examples provided by human experts), but can alternatively be unprimed, unconditioned, operate without examples, and/or be otherwise instructed. The agents are preferably prompted with a prompt and a context (e.g., the document, set of entity relationships, etc.), wherein the agent returns a response based on the context.

The agents are preferably language models (e.g., LLMs), but can additionally or alternatively be CNNs, DNNs, generative models, transformers, autoencoders, recurrent neural networks (RNNs), long short-term memory (LSTM) networks, gated recurrent units (GRUs), graph neural networks (GNNs), variational autoencoders (VAEs), generative adversarial networks (GANs), diffusion models, mixture-of-experts models, ensemble models (e.g., gradient-boosted trees), and/or any other suitable type of model. The agents are preferably natural language models (e.g., ingest natural language prompts), but can alternatively include decoders (e.g., ingest embeddings, feature vectors, etc.), vision models, visual-language models, audio models, speech models, mixed modality models, and/or any other models.

For example, a propagation agent or relationship agent can be implemented as a natural-language model that receives attributes and relationship information represented as natural-language text and generates natural-language text describing updated precedential statuses and relationship states.

In a first example, an agent can be provided with a document (the context) and be prompted to identify all entities referenced within a document and describe the document's treatment of each identified entity.

In a second example, an agent can be provided with a list of related documents, the respective relationship descriptions, and a query (the context), and be prompted to return identifiers for documents from the list that are relevant to the query.

In a third example, an agent can be provided with a set of documents, optionally the relationships therebetween, and a query, and be prompted to generate a response to the query based on the set of documents.

Determining a new entity S100 functions to receive new source of data, wherein the new source of data can include new statutes, new tax case laws, changes to existing forms, and/or any other suitable new sources of data.

The entity can be a document (e.g., text), video, audio, image (e.g., photograph, scanned page, diagram), slide deck, web page, email, chat or messaging transcript, spreadsheet or table, database record, code or repository artifact, sensor or telemetry time-series, transaction log, and/or have any other suitable modality.

The entity can include statutes, legislation (e.g., federal, state, county, city, etc.), regulations, case law, and/or any other suitable entities. In examples, entities can include legal documents (e.g., legal cases, court holdings, statutes, legislative history, bills, treaties, regulations, administrative holdings, judicial holdings, contracts and agreements, etc.), tax documents (e.g., legal cases, tax forms, tax code, IRS notices, revenue rulings, procedures, audit reports, etc.), announcements (e.g., by an administration, by a standards-setting body, etc.), standards (e.g., GAAP, GASB, etc.), rules, policies (e.g., federal reserve policies, etc.), industry trends, common practices, presentations, internal documentation (e.g., tax returns, legal memos, accounting memos, internal communications, internal policies, etc.), and/or any other suitable entities.

S100 can be performed by a user, a data ingestion agent, web-scraping agent, crawler agent, API integration agent, and/or any other suitable performer. S100 can be performed continuously, periodically or aperiodically, on a predetermined schedule, when a webhook is triggered, when a new entity is published to a monitored stream, every time a user uploads a new file, every time an API call is detected, and/or any other suitable timing or trigger condition.

In a first variant, new entities can be automatically retrieved from a data source. The source can be specified by a user, automatically determined, be a set of predetermined sources, and/or any other suitable source determination method. The data can be automatically retrieved by scraping or crawling a webpage, requesting documents from API endpoints, monitoring a source for changes, and/or any other suitable retrieval method.

In a second variant, users can upload data (i.e., accounting memos, etc.), and/or any other suitable data.

In a third variant, entities can be received from event-driven or push-based integrations.

However, determining a new entity S100 may be otherwise performed.

Constructing a self-organizing knowledge graph (SOKG) S200 functions to represent the entities and the relationships between them.

The method can be used with one or more SOKGs, wherein different SOKGs can be associated with different knowledge domains (e.g., accounting vs corporate law, math vs. legislature, etc.), different companies (e.g., wherein each company has its own private SOKG), and/or any other suitable differences. Examples are shown in FIG. 2, FIG. 4, and FIG. 7.

S200 can include generating a new knowledge graph, updating an existing knowledge graph, and/or otherwise constructing a SOKG. Updating an existing knowledge graph can include adding a new node (e.g., entity) to the knowledge graph, updating a value of a pre-existing node in the knowledge graph, and/or any other method of updating an existing knowledge graph. Updating a value of a pre-existing node in the knowledge graph can include updating a precedential status of the pre-existing node (e.g., changing the binding status from overruled to reversed, changing the validity value from invalid to valid, etc.), updating a relationship of the pre-existing node (e.g., adding a new related entity, updating the relationship status of the relationship, etc.), updating the attribute value of the pre-existing node, adding new attribute types to the pre-existing node (e.g., adding new tags, new feature variables, new facets, etc.), updating the topics of the pre-existing node, and/or any other method of updating a value of a pre-existing node.

When the system includes multiple SOKGs, the SOKGs can be connected or disconnected. The connections between SOKGs can include cross-graph relationships between entities in different SOKGs (e.g., an entity in a private SOKG referencing a related entity in a public SOKG), shared entity identifiers or keys that cause entities in different SOKGs to be treated as versions of the same underlying authority, mappings between attribute sets (e.g., jurisdiction, code section, docket number) that link conceptually-related entities across SOKGs, routing rules that allow traversal agents to hop between SOKGs during query processing, and/or any other connection. In examples, the connections can be constrained by access-control or tenant boundaries (e.g., only public entities or whitelisted relationships are traversable between SOKGs), jurisdictional or data residency rules (e.g., cross-SOKG traversal disabled between entities stored in different regions), regulatory firewalls or ethical walls (e.g., preventing traversal between SOKGs associated with different clients or matters), environment or lifecycle separation (e.g., no traversal between staging and production SOKGs), and/or any other suitable policy or governance constraints. The connections between SOKGs can have properties including directional or bidirectional connections, connections that can be created explicitly (e.g., curated mappings), connections that can be created implicitly (e.g., automatically inferred based on overlapping citations, attributes, or embeddings), connections that can have associated weights, priorities, or confidence scores that influence traversal, and/or any other suitable connection properties.

In disconnected SOKG configurations, each SOKG can be logically and/or physically isolated such that entities, relationships, and metadata in one SOKG are not visible to traversal agents operating on another SOKG. Additionally or alternatively, disconnected SOKGs can lack cross-graph relationships or shared identifiers, such that entities are not merged across SOKGs, and queries are optionally evaluated only against the SOKG (or subset of SOKGs) selected for that tenant, user, or use case.

In an example, a set of private SOKGs (e.g., formed from documentation internal to the company) can reference entities in a public SOKG (e.g., formed from publicly-available data), but the public SOKG entities preferably do not reference entities in a private SOKG, but can additionally and/or alternatively reference entities in a private SOKG, and different private SOKGs are preferably separate and discrete (e.g., not reference entities in another private SOKG), but can additionally and/or alternatively reference entities in another private SOKG.

In a specific example, one SOKG can represent a global corpus of tax codes, regulations, and rulings, while separate SOKGs represent private internal know-how for different companies or firms (for example, memoranda and internal communications for a particular tax practice), and the system can link and traverse these graphs together when answering a query for that company.

In another example, different tax codes, regulations, and rulings can be stored in different SOKGs.

However, the multiple SOKGs can be otherwise related and/or connected in any other suitable manner.

S200 can be performed by: an entity recognition agent (e.g., that locates or assigns unique entity ID to datum), relationship extracting agent (e.g., that extracts relationships of entities), embedding agent (e.g., that generates vector embeddings for each entity and relationship), graph update agent (e.g., that updates existing entities metadata based on attributes of new entity, validates relevance and establishes a relationship between new and existing entities, etc.), query processing agent (e.g., that receives and parses user query), UI agent, and/or any other suitable agent.

In variants, constructing a self-organizing knowledge graph (SOKG) S200 includes determining data for the new entity S220; updating existing entities S240; determining existing entities related to the new entity S242; and updating existing entity information S244.

Determining data for the new entity S220 functions to determine a compact representation of the entity. S220 can be performed in parallel with updating existing entity information, but can alternatively be performed in series and/or in any other suitable execution order. The resultant entity data is preferably stored in the same database, but can alternatively be stored in different databases (e.g., separate embedding and attribute databases; separate embedding and relationship databases; etc.), and/or any other suitable storage configuration.

The entities can be stored as nodes within a graph, nodes in a tree structure (e.g., parent-child relationship), vectors in vector space, entries in a relational table (e.g., entities as rows, and columns as attributes), objects in a document store (e.g., JSON or BSON documents in a document database), key value pairs in a key value store, triples in a triple-store or RDF store, entries in a columnar or time-series database, files or blobs in an object store with references in an index, or records in an inverted index used by a search engine, and/or any other suitable storage format.

The entity data for an entity can include an entity identifier, entity embedding set (e.g., representation in a latent space), entity attribute set, relationships, precedence, and/or any other suitable entity information. In some embodiments, the entity data for a newly received document can further include relationship state descriptive of one or more relationships between the new document and existing documents, determined based on information extracted from the content of the new document.

The entity identifier can function to uniquely identify the entity. The entity identifier is preferably semantic, but can alternatively be non-semantic. In a first example, semantic identifiers can include document name, case name, docket number, statute name, and/or any other suitable semantic identifiers. In a second example, non-semantic identifiers can include document receipt order, hash of the document content, and/or any other suitable non-semantic identifiers. The entity identifier can be extracted from the entity (e.g., from the title, etc.), from the entity context (e.g., from the hierarchy that the entity is within, from the entity retrieval order, etc.), and/or from any other suitable information. Each entity is preferably associated with a single identifier, but can alternatively be associated with multiple identifiers. For example, an entity can be associated with a human-readable semantic identifier (e.g., case name), a stable non-semantic identifier (e.g., a UUID or hash of the content), and one or more external system identifiers (e.g., a docketing system ID, document management system ID, or database primary key).

The entity embedding set functions to represent the entity's content using a ML-compatible representation in a latent space (e.g., semantic space). Alternatively, the system does not include entity embeddings (e.g., the entity representations are all in natural language). The entity embedding set can be extracted using a set of encoding layers (e.g., encoder, attention layers, etc.), an encoder, using a pre-trained model (e.g., word2vec, BERT, GPT, etc.), and/or any other suitable extraction method. Different instances of embedding determination preferably use the same encoding model (e.g., to embed into the same latent semantic space), but can alternatively use different encoding models and/or any other suitable encoding configuration. The entity embedding set can be stored in association with an entity identifier. The entity embedding set can be for the entire entity (e.g., entire document), sections of the entity, hierarchical sections of the entity, and/or any other suitable portions of the entity. The entity embedding set can be stored with the entity attribute set or be stored independent of the entity attribute set, and/or any other suitable storage configuration.

The entity attribute set can describe one or more dimensions of the entity. For example, the dimensions can include: a substantive dimension (e.g., topic, issue area, practice area, industry), a temporal dimension (e.g., filing date, effective date, expiration date), a jurisdictional dimension (e.g., country, state, court level), a procedural dimension (e.g., trial court, appellate decision, remand order), a role dimension (e.g., plaintiff, defendant, taxpayer, agency), an authority dimension (e.g., binding, persuasive, overruled, distinguished), and/or any other dimension. In a further example, the dimensions can include a relational dimension (e.g., which entities the authority cites, overrules, or follows), a confidence dimension (e.g., model confidence or validation status), and/or a usage dimension (e.g., frequency of citation in downstream work product), and/or any other dimension.

The entity attribute set can describe the entity's content, metadata (e.g., provenance, issuing authority, issuance time, jurisdiction, location, etc.), relationships with other entities, and/or any other suitable characteristics. The entity attribute set can include attributes, attribute values, attribute metadata (e.g., document citation, document section identifier, number of relevant sections, etc.), and/or any other suitable elements. The entity attribute set can be stored as tags, text descriptions, key-value pairs (e.g., “case_type: civil rights”), hierarchical attributes (e.g., “supreme court case” supersedes “federal court case”, which supersedes “jurisdiction court case”, etc.), and/or any other suitable storage format.

The attributes (e.g., variables, keys, etc.) preferably dynamically determined, and do not conform to a strict schema, but can alternatively conform to a loose schema (e.g., general attribute categories, such as “relationships with other entities”, “key topics”, etc.), hybrid schema (e.g., with undefined or loose schemas for some attributes, and strict schemas for other attributes), strict schema (e.g., “jurisdiction:”, “referenced entities:”, etc.), and/or other schema. When a schema is used, the schema can be received from a user, extracted from standardized references, and/or otherwise determined.

When the attributes are dynamically determined, the attributes are preferably determined from the document, but can alternatively be determined from related documents.

The attributes are preferably independently determined by an agent (e.g., large language model, generative model, CNN, DNN, etc.) without reference to a schema, but can alternatively be determined by an agent with reference to a set of examples, a loose schema, a strict schema (e.g., wherein the agent can only select attributes from the strict schema), and/or any other suitable reference.

In variants, attribute extraction can be implemented as a hybrid workflow in which a human or administrator can specify a seed set of attributes of interest and/or an attribute-determination agent is further instructed to propose additional “interesting” or “important” attributes discovered in the entity content beyond the seed set. This can result in different attribute names for similar concepts (e.g., “jurisdiction” vs “court name”).

Examples of attributes that can be used can include time (e.g., of entity issuance, entity publication, etc.), references to other entities cited within or related to the entity, entity classification (e.g., statute, return, ruling, etc.), private vs public documentation, jurisdiction or authority issuing the entity (e.g., federal, state, etc.), doctrinal status (e.g., binding, persuasive, overruled, distinguished), procedural posture (e.g., trial decision, appellate opinion, remand order), subject-matter or practice area (e.g., corporate tax, estate planning, international tax), industry or sector, effective date range, affected taxpayer profiles (e.g., individuals, pass-through entities, multinational groups), risk or materiality indicators (e.g., high-risk issue, frequently litigated issue), relationship summaries (e.g., statements such as “primarily cited for definition of term “X”, “frequently relied upon in transfer-pricing disputes”, etc.) that reflect how the entity is used in the corpus, and/or any other suitable attributes. The attributes preferably include relationships with other entities, but can alternatively exclude relationships with other entities (e.g., wherein relationships with other entities are a separate entity parameter).

The attribute values can be values for the attribute. The values are preferably extracted from the document content, but can alternatively be from the document context, data source, from other documents, and/or any other suitable source. In an example, documents received through a UI can be marked as “private”, while documents scraped from public sources can be marked as “public”. The values can be extracted after entity attribute set extraction, but can alternatively be extracted at the same time. In an example, a set of attributes can be identified from the document (e.g., using an agent), wherein an agent is then prompted to determine the values for each identified attribute in the set. In an example, an agent is prompted to determine the attributes and values from a document.

The attribute values are preferably a natural language description (e.g., multiword description; qualitative description, etc.), but can alternatively be classification (e.g., from a set of predetermined classes, etc.), numerical value, and/or any other suitable description.

The attribute values are preferably independently determined by an agent (e.g., large language model, generative model, CNN, DNN, etc.) without reference to a schema of predefined values for the attribute, but can alternatively be determined by an agent with reference to a set of example values for the attribute, a loose schema, hybrid schema (e.g., with permissible values defined for some attributes but no value constraints defined for other attributes), a strict schema (e.g., wherein the model can only select from a set of predefined attribute values), and/or any other suitable determination method.

When a schema or ontology is used, the schema or ontology can be received from a user, extracted from standardized references, and/or otherwise determined.

In a first example, the agent independently determines an attribute value, wherein the document or section thereof is passed to the model with a prompt to determine the attribute value (e.g., “describe the relationships to all entities referenced in the document”).

In a second example, the agent determines the attribute value, wherein the document or section thereof is passed to the agent with a prompt to determine the attribute value from a set of predefined values (e.g., “determine whether each relationship to a referenced entity is [‘overturned’, ‘upheld’, ‘superseded’, . . . ]”).

In a third example, a model is trained to predict a predetermined set of relationship classes (e.g., multiheaded classifier trained to predict a predetermined relationship class based on the document text).

In variants, attribute value determination for a given entity can be repeated (e.g., periodically, when a new entity references the entity, etc.) to update the attribute values. In an example, attribute values can be recomputed when a new authority cites, overrules, or otherwise changes the treatment of the entity, when new training data or models are deployed, or when a user flags an attribute as incorrect or incomplete.

The identified attributes can optionally be validated (e.g., using a human in the loop validator, using a second validation model, etc.).

In an example, a validator agent can be prompted to verify that the attribute is relevant or appears in the document. In an example, a validator agent can be prompted to verify that the attribute also appears in or is similar to other entities'attribute sets. In variants, this can enable the system to adapt its ontology over time as new entities and contexts are introduced. In examples, the validator agent can additionally assign a confidence score, explanation, or rationale for each accepted or rejected attribute value, and such validation metadata can be stored with the entity for downstream use (e.g., retrieval, ranking, or auditing). In variants, disagreement between different validators (e.g., two models, or a model and a human) can be logged as a conflict and optionally routed for human review, and the resolution can be used to refine prompts, thresholds, or schemas used by the ingestion agents. In some implementations, validation outcomes can be aggregated across entities to promote frequently validated attributes or values into a stricter schema (e.g., upgrading free-form tags into a standardized attribute with enumerated values). In related variants, the system can maintain an audit trail for each attribute value, including which agent proposed it, which validator agent approved or rejected it, and timestamps for proposal and validation.

In an example, a validator agent can be prompted to verify that the attribute also appears in or is similar to other entities'attribute sets.

In further variants, the system can compare new attribute values to prior attribute values and record only changes that exceed a threshold difference (e.g., semantic distance or numeric delta), thereby reducing churn while still capturing materially meaningful updates.

However, determining data for the new entity S220 may be otherwise performed.

Updating existing entities S240 functions to update the SOKG to reflect the new information. S240 enables existing entities to be kept up to date given new information, even when the new information (e.g., the new entity, the new document, etc.) does not reference the existing entity (e.g., directly or indirectly). S240 can further minimize additional processing during query response time, which can conserve computational resources and increase query response speed.

In an example, updating existing entities includes determining an updated precedential status for a first existing entity based on relationship state between a new entity and a first existing entity, and propagating precedential statuses to other existing entities (e.g., connected to previously updated entities, connected to previously identified related entities, etc.). In an example, the updated information for the existing entity (e.g., updated precedential status, updated validity value, updated relationship value, etc.) is not extracted from the new information (e.g., from the new entity).

The existing entities that are updated or evaluated for updating can include all entities related to the updated entity (e.g., directly or indirectly), a subset of entities related to the updated entity (e.g., related to an Nth degree, related by the updated piece of information, related by an attribute, related by a relationship, etc.), entities that are unrelated to the updated entity, and/or any other entities.

The existing entity can be related to the updated entity by a stated relationship (e.g., the existing entity or the updated entity references the other entity), shared attribute values, shared semantics, and/or any other relationship or method. In an example, an existing entity can be related to the updated entity by an explicit stated relationship (e.g., the updated entity cites the existing entity, the updated entity and the existing entity both reference the same IRC section, etc.), by shared semantics (e.g., shared fact patterns, etc.), by shared attributes (e.g., shared topics, shared judge, shared author, shared industry, etc.), and/or by other shared pieces of information.

Related entities can be identified according to a rule set, by prediction using a model (e.g., the propagation agent, etc.), based on one or more similarity scores (e.g., between the same type of information, etc.), and/or otherwise identified. In an example, when predicted by a model, the extracted information for the updated entity and the existing knowledge graph, a representation thereof, or a subset of the information within the knowledge graph (e.g., the entity identifiers, the relationships, the values for a subset of the attributes, etc.) is passed to the model, wherein the model identifies which existing entities should be subsequently updated based on the passed information. In another example, when determined based on similarity scores, entities can be related by semantics (e.g., similar content, similar semantic embeddings, etc.), fact patterns, attribute values (e.g., topic, judge, author, etc.), relationships, and/or otherwise related. The information type compared for similarity can be predetermined or dynamically determined (e.g., selected by the propagation agent, by another model, etc.).

One or more of the existing entities can be updated: serially (e.g., sequentially), in parallel, in batches (e.g., batched by degree of relationship, type of relationship, shared attributes, etc.), and/or otherwise updated.

S240 can be performed each time a new entity is added, each time a new relationship is added, at any other time, and/or alternatively can not be performed.

S240 can include identifying entities related to the current entity, updating the related entity's attributes based on the relationship between the current entity and the related entity, repeating the process wherein the related entity is treated as the current entity, and/or otherwise updating existing entities.

Different pieces of existing entity information can be updated in the same pass or in different passes.

In a first variant, updating existing entities S240 can include updating all pieces of information for the existing entity at the same time (e.g., in a single pass, in a single instance of S240).

In a second variant, updating existing entities S240 can include updating different pieces of information for the existing entity in different passes (e.g., in different instances of S240). In an example, attributes are updated in one pass, while relationships can be updated in another. The passes can be serial (e.g., order can be manually determined, predetermined, etc.) or in parallel.

Different pieces of existing entity information can be updated using the same or different inputs. In a first example, the existing entity's precedential status is updated based on intervening entity relationships, while the existing entity's attribute values are updated based on the attribute values for the new entity and the existing entity's attribute values. In a second example, the existing entity's precedential status can be updated based on only intervening relationships. In a third example, the existing entity's precedential status can be updated based on intervening entities'relationships and semantics. In a fourth example, the existing entity's precedential status can be updated based on all information from one or more intervening entities (e.g., relationships, attributes, precedential status, semantics, etc.).

The existing entity's semantics (e.g., content) are preferably not updated based on the new information, but can alternatively be updated.

However, S240 can update any other piece of existing entity information.

The existing entity's information can be updated based on the new entity's information (e.g., attributes, relationships, topics, semantics, etc.), the existing entity's prior information (e.g., semantics, attribute values, relationships, etc.), intervening entities'information (e.g., semantics, attribute values, relationships, etc.), updated information of other existing entities, and/or any other information.

In an example, updating the related entity's attributes can include updating the related entity's precedential status (e.g., changing the validity status to “invalid” when the new entity overturns the related entity), or updating the related entity's relationships. The existing entity's information is pref updated based on the information from the chain of intervening entities connecting the updated entity (e.g., new entity, newly-updated entity, etc.) to the existing entity, but can alternatively be updated based on only the new information, information from a subset of the intervening entities, and/or other information.

The existing entity's information can be updated in light of the confidence scores for the respective pieces of information.

In a first example, the existing entity's information (e.g., precedential state, relationship state, etc.) can be overwritten based on the new information, even when the existing entity's information had a high confidence score. For example, the high-confidence existing entity information can be overwritten when the new information has a confidence score over a threshold value (e.g., over the existing information's confidence score, over a predefined threshold, etc.). In specific examples, lower-confidence new information can change higher-confidence entity information (e.g., precedence states) when the new information was issued by a higher authority, when the new information is associated with no chance of appeal, and/or when other conditions are met.

In a second example, the existing entity's information can be updated to an intermediary value (e.g., “questioned” instead of “rejected”) when the new information contradicts the existing entity and has a lower confidence score than the existing information.

In a third example, the respective confidence scores for the new information and existing information can be passed to the propagation agent alongside the information itself, wherein the propagation agent can predict the updated information for the existing entity.

In a first variant, the updated information values for the existing entity can be determined using a set of rules. In this variant, the rules can specify the relationship type, given the current entity's precedential values, relationship values, attribute values, changes thereof, and/or other data. In a first example, the existing entity can be overruled when a precedential case is overruled and when the precedential case was central to the existing entity's holding. In a second example, the existing entity can be “undermined by” or set to a “caution” or “pending review” or “mixed treatment” status when the precedential case was overruled.

In a second variant, the updated information values for the existing entity can be determined by a propagation agent. The model can predict, infer, and/or otherwise determine the updated information values.

In a first example, the updated information values are determined based on a chain of relationships between entities connecting the updated entity (updated based on the information) and the pre-existing entity. In an example, the propagation agent can include a generative model configured to ingest a set (e.g., a sequence) of relationships connecting a new entity and an existing entity (e.g., including relationships between one or more intervening entities), and to infer an updated precedential status for the existing entity based on the sequence.

In a second example, the propagation agent computes a confidence score for an updated precedential status for an entity, compares the confidence score to a threshold (e.g., standard threshold, the confidence score of the precedential status of an existing entity, etc.), and decides whether to overwrite a prior precedential status based on both the confidence comparison and the new entity information.

In a third example, the series of relationships between the updated entity and pre-existing entity can be passed to the propagation agent (e.g., LLM), wherein the model predicts the updated existing entity's information (e.g., precedential value, relationship between the updated entity and pre-existing entity, etc.) based on the series of relationships. In variants, the updated relationship can additionally or alternatively be predicted based on: the new information extracted from the updated entity (e.g., as a conditioning signal); the substance of the entities (e.g., the updated entity, the pre-existing entity, the intervening entities, etc.); and/or other information. The substance of the entities can include entity fact patterns, full text of the entity, summaries of the entity, attribute values of the entity, and/or any other substance. The series of relationships can include: for each intervening entity in the chain of relationships: the intervening entity identifier, the relationship to the prior entity in the series, the relationship to the subsequent entity in the series, and/or other information. The relationships between entities are preferably sequentially updated, such that the intervening entity's relationship to the prior and subsequent entities were already updated using a prior instance of S240, but can additionally or alternatively be updated in parallel or otherwise updated.

However, updating existing entities S240 may be otherwise performed.

Determining existing entities related to the new entity S242 functions to identify and establish relationships in the SOKG between the new entity and existing entities. S242 can be performed using the entity attribute set determination methods discussed above (e.g., be part of S220), but can alternatively be separately determined and/or determined using any other suitable methods.

The relationship preferably describes the legal treatment of the existing entity by the new entity (e.g., a shepardization), but can additionally or alternatively simply be a reference to the existing entity and/or be another relationship.

In a first example, legal treatment can include strong negative treatment, possible negative treatment, positive treatment, and/or any other treatment types.

In a second example, strong negative treatment can include overruled by, questioned by, superseded by, revoked, obsolete, rescinded, and/or any other suitable strong negative treatment.

In a third example, possible negative treatment can include limited, criticized by, clarified, modified, corrected, and/or any other possible negative treatment.

In a fourth example, positive treatment can include followed, affirmed, approved, and/or any other suitable positive treatment.

The relationship can be represented by a text description (e.g., attribute), an explicit edge, a pointer, a tag associated with the new and/or existing entity, and/or any other suitable representation method. In variants, the relationships can optionally be weighted (e.g., representing relevance, frequency, strength of connection, priority, confidence score of the relationship prediction, etc.).

The relationships can be directional (e.g., one entity cites another) or undirected (e.g., cases sharing a common jurisdiction, tax returns filed by the same taxpayer, etc.).

S242 can be performed by a relationship agent, and/or by any other model or agent. The relationship agent can be guided with soft instructions (for example, to pay attention to explicit citations or shepherdization patterns). The relationship agent can also be allowed to self-organize additional relationship categories, such as linking court cases that were decided by the same judge. The self-organizing knowledge graph can be constrained to a fixed catalog of relationship types and/or alternatively not constrained to a fixed catalog.

In a first variant, S242 can include relationship extraction that is fully unstructured, wherein an agent is prompted to describe the relationships with any entities mentioned within the document (e.g., wherein neither the relationships nor the entities are identified in the prompt). In an example, a single AI agent can be instructed to extract referenced entities and the document's relationship to the referenced entities, and/or any other suitable relationship extraction method.

In a second variant, relationship extraction can be structured, wherein referenced entities are explicitly determined in a first pass, and the relationships for each entity are determined in a second pass. Referenced entities are preferably determined by prompting an agent (e.g., LLM, DNN, etc.) to return entities referenced by the new entity, but can alternatively be determined using a model trained specifically to identify entities (e.g., an NER model, etc.), and/or any other suitable determination method. Entity relationships are preferably determined by prompting an agent (e.g., LLM, DNN, etc.) to describe the relationship between the new entity and each referenced entity (e.g., specifically identified in the prompt), but can alternatively be determined by prompting the model to classify the relationship as one of a predetermined set of classes, by passing the new entity and the referenced entity to a classifier trained to classify the new entity's relationship with (e.g., treatment of) the referenced entity, and/or any other suitable determination method.

In a first example, a first AI agent extracts the referenced entities (e.g., first LLM instructed to extract all entities from the document), while a second AI agent determines the classification (e.g., second LLM instructed to determine the document's treatment of each entity extracted by the first LLM).

In a second example, a first model (e.g., NER model, LLM, etc.) extracts the referenced entities, while a classification model (e.g., CNN, DNN, etc.) determines a relationship classification (e.g., from a set of predetermined classifications) for each referenced entity based on the document.

In a first variant, adding the new entity to the SOKG can include adding the entity data for the new entity to a database.

In a second variant, adding the new entity can include adding a node representing the entity, storing the entity data in association with the node, and setting edges based on the identified relationships (e.g., edges between the new node and nodes for the existing entities, wherein the edges are associated with the description for the respective relationship). In an example, when a new document indicating that an existing entity (e.g., case) has been overturned is added to the graph, a new node is added to the SOKG for the new document, and a new edge with an “overturned” relationship classification and connecting the new node to the existing entity node is added to the SOKG.

However, determining existing entities related to the new entity S242 may be otherwise performed.

Updating existing entity information S244 functions to ensure that the existing entity information is updated in light of new information from the new entity. The existing entity information is preferably updated by the propagation agent, but can alternatively be updated by any other agent.

In a first variant, S244 can include passing the existing entity information and the new entity information to the propagation agent (e.g., an LLM), wherein the propagation agent can generate updated information for the existing entity or propose changes to the existing entity's information values.

In a second variant, S244 can include comparing the existing entity information with the new entity information (e.g., by comparing pieces of information with the same tags, same attributes, etc.), and updating the existing entity with the new entity's information values.

In a third variant, S244 can include updating the related entity's attributes using a set of rules, wherein the rules specify how the related entity's attribute values should be updated, based on the new entity's attribute values (ex. strictly add entity and relationship).

In a fourth variant, the attributes can be updated using an agent (e.g., LLM, DNN, etc.), wherein all or a portion of the new entity's attribute set and the related entity's attribute set are passed to the model (e.g., LLM, DNN, etc.), and the model can determine what values to use in the update and/or which attributes to update.

However, S244 can otherwise update the existing entity information.

S244 can optionally include updating a relationship between the existing entities. The updated relationship can be between an existing entity and the new entity, between existing entities, and/or between any other set of entities. The updated relationship can be explicitly stored or implicit. Updating the relationship can include updating a connection between two entities (e.g., creating a relationship, removing a relationship, etc.), updating a label associated with the relationship (e.g., precedential status, etc.), and/or updating any other component of a relationship.

In a first example, updating existing entity relationships can include adding a relationship to the new entity's relationships (e.g., “overturned by Google vs. . . . ”). In a specific example, the set of relationships of the existing entity can be updated to include a relationship back to the new node (e.g., tagged with “overturned by”).

In a second example, updating existing entity relationships can include updating the related entity's relationships with other entities based on the related entity's relationship with the new entity (e.g., propagating changes more than one degree out). In a specific example, the new relationship is propagated to all or a portion of the relationships of the existing entity (e.g., updated with “overturned by new_node_identifier”).

In variants, changes can be propagated to successively related entities: until the model determines that no changes are needed for the related entity, a depth limit is reached (e.g., changes have been propagated 3 degrees out from the new entity), a predetermined number of entities have been evaluated, a predetermined set of heuristics have been satisfied, a convergence condition has been met (e.g., the same entities are visited for updating across successive iterations), and/or when another stop condition is reached. In some implementations, when a precedential status is updated for a given entity, the system can also update one or more additional attributes (such as risk indicators or warning flags) for entities that are within a maximum propagation depth measured in relationship steps from that entity. The system can treat precedence or validity as a status signal and propagate updated precedential statuses along the same chains of relationships, so that entities within a specified propagation depth inherit or adjust their precedential statuses based on updates to upstream entities.

In a third example, the existing entity's attribute set is not updated based on the new entity.

S244 can optionally include updating the precedential state of the existing entities. In an example, updating the precedential state of the existing entities can include using a ruleset specifying precedence (e.g., whether the issuing authority for the new entity controls). For instance, when a new entity provides positive treatment (such as following, approving, or affirming) of an existing entity that was previously treated as overruled or undermined, the system can change the precedential status of the existing entity from an overruled status to an affirmed or otherwise more favorable status based on the positive treatment relationship state determined for the new entity. In another example, updating the precedential state can include passing the current precedential state of the existing entity, the relationship classification, and the attributes of the new entity (e.g., jurisdiction, etc.) to an agent (e.g., transformer, LLM, etc.), and prompting the agent to determine an updated precedential state.

S244 can optionally include verifying and/or resolving conflicts. Verifying and/or resolving conflicts can function to increase the confidence that the entity data stored in the SOKG is valid. The verification and/or conflict resolution can be performed separately, concurrently, and/or in any other suitable order with the remainder of S200. The confidence increase can be quantitative, qualitative, and/or any other suitable type of increase.

In a first variant (e.g., example shown in FIG. 2), the entity data (e.g., attribute value, identifier, embedding, etc.) determined in S220 and/or S240 can be passed to a verifying agent (e.g., LLM, DNN, etc.) with the new entity, existing entity, existing entity data, and/or any other suitable data, wherein the ML model verifies or denies the validity of the entity data. The entity data can be added to the SOKG when the verifying agent verifies the data, and new entity data can be determined when the verifying agent denies the data (e.g., S220 and/or S240 can be repeated to obtain different data values).

In a second variant, verifying the data can include verifying the entity data based on a confidence score of the data prediction. In an example of the second variant, the entity data can be treated as verified when the confidence score is above a threshold, and treated as denied when the confidence score is below a threshold, and/or otherwise implemented using any other suitable verification method.

In a third variant, verifying and/or resolving conflicts can be based on predefined rules. Conflicts can include disagreements between new and existing values of the same attribute for a given entity, disagreements between values of related attributes for a given entity, and/or any other suitable conflicts. In a variant, conflicts can include further monitoring dissimilarities between old and new attribute sets or embeddings that exceed a configurable threshold, wherein the dissimilarities can trigger an alert or briefing workflow for a user, (e.g., a tax professional). In a first example, if a conflict arises from a new entity relationship that contradicts existing relationships, the newest relationship controls. In a second example, if a new entity (e.g., document 3) describes a relationship between two other entities (e.g., doc 1 and doc 2) that conflicts with the relationship directly stated in those entities, then those direct relationships control. In a third example, relationships stated by precedential or controlling authorities control (e.g., relationship between two entities stated in the majority opinion of a Supreme Court case controls). In a fourth variant, resolving conflicts can be based on a voting mechanism. In an example of the fourth variant, the supporting and contradicting relationships can be counted and the relationship with the highest count or support can be prioritized, and/or any other suitable resolution method can be implemented.

However, updating existing entity information S244 may be otherwise performed.

However, constructing a self-organizing knowledge graph (SOKG) S200 may be otherwise performed.

Receiving a query S300 functions to allow a user to query the SOKG. The query can be received from a user (e.g., tax professional, accountant, lawyer, etc.), automated system (e.g., via an API, a process that runs periodically, etc.), and/or any other suitable source.

In a first example, the method can automatically generate periodic audit or briefing reports, (e.g., a daily summary of tax law or policy changes that affect a particular taxpayer or industry, a “baseball card”, etc.) using a periodic, predefined automated query.

In a second example, the method can receive a query, traverse the SOKG, aggregate information from entities relevant to the query (e.g., based on a similarity score between semantics, attributes, relationships, etc.), and generate a response from the aggregated information.

The query can be received by a query processing agent, tokenizing agent, a UI agent, NLP agent, and/or any other suitable agent (e.g., examples shown in FIG. 3, FIG. 4, and FIG. 8). In some variants, the query processing agent can be an AI agent that dynamically selects retrieval tools (for example, embedding search, keyword or attribute filters, or combinations thereof) by constructing tool calls to underlying services at run time.

In a first example, a query processing agent can normalize or rewrite the query (e.g., expand abbreviations, correct spelling, convert form-based selections into a text prompt) before passing the normalized query to the query processing agent.

In a second example, S300 can be performed using a routing or orchestration agent that can inspect the query (e.g., query length, presence of filters, modality) and select between multiple query processing agents specialized for different tasks (e.g., fact questions, research tasks, audit requests).

In a third example, a classification agent can determine a query type or class (e.g., “point-in-time authority”, “planning scenario”, “change-detection audit”, etc.), and annotate the query with corresponding attributes (e.g., jurisdiction, time period, entity type, risk category, and/or other suitable attributes, etc.) before traversal is performed.

The query can be a text query, set of keywords, images, audio, video, and/or any other suitable query type. The query is preferably unstructured, but can alternatively be structured. The query is preferably in natural language, but can alternatively be quantitative, in a structured language, and/or otherwise constructed. In examples, the query can include structured parameters (e.g., jurisdiction, tax year, entity type, threshold amounts, include/exclude lists) provided through a form, UI filters, or an API request, which can be converted into attributes or constraints for S400. The query can additionally or alternatively be a document or collection of documents (e.g., uploaded return, memo, contract, or brief) for which the user requests analysis, comparison, or identification of relevant authorities in the SOKG. The query can additionally be a programmatic or system-initiated query (e.g., an automated daily audit query, watchlist query, or monitoring query) generated by another system or agent without explicit user input.

S300 can include extracting information from the query. The extracted information can include an attribute set, relationships, semantics, and/or any other information. The information can be extracted by the same or different models (e.g., agents) used for new entity information extraction (e.g., in S200). Different pieces of information can be extracted using the same or different models.

In an example, S300 can include extracting an attribute set for the query (e.g., examples shown in FIG. 2 and FIG. 7). The extracted attribute types and values can be based on an ontology or schema defined by the knowledge graph, be unconstrained (e.g., wherein query information extraction is ontology-and/or schema-free), and/or otherwise extracted. In an example, an agent can aggregate the ontology and/or schema from the self-organizing knowledge graph (e.g., by traversing the attribute types, the tags, etc.), and pass the aggregated ontology and/or schema to the query processing agent, wherein the query processing agent can then extract attribute types and values defined by the aggregated schema and/or ontology from the query.

In an example, S300 can include extracting relationships from the query. In a specific example, extracting relationships from the query includes identifying an existing entity identifier in the query and optionally determining (e.g., predicting) a relationship to the identified existing entity (e.g., distinguish over the existing entity, similarities with the existing entity, etc.).

The query can optionally be embedded into a semantic latent space (e.g., the same space as the entity embeddings). The query can be embedded by the same encoder used to determine the entity embedding, by a different encoder used to determine the entity embedding, and/or any other suitable encoder.

However, receiving a query S300 may be otherwise performed.

Traversing the self-organizing knowledge graph based on the query S400 functions to identify entities in the SOKG that are related to the query (e.g., example shown in FIG. 3).

In examples, an entity can be treated as related to the query based on one or more relationships (e.g., explicit citations, treatment relationships, dependency or lineage links, cross-references, etc.), one or more topics or subject-matter attributes (e.g., practice area, industry sector, issue type, doctrine, etc.), one or more attribute values (e.g., jurisdiction, time period, entity type, risk category, or other metadata), semantic similarity between the query and the SOKG entity, and/or any other piece of information. An entity can be considered to be related to the query as discussed above (e.g., based on a rule set, identified as related by a model, determined based on similarity scores, etc.), but can alternatively be otherwise determined to be related.

S400 can be performed by a query processing agent (e.g., an LLM, DNN, rule set, etc.), and/or any other suitable processing agent. In examples, S400 can be implemented by a traversal or exploration agent that, given an initial entity set, selects which neighboring entities and relationships to follow at each step based on the query, the entity attribute sets, and/or the traversal history. In variants, the traversal agent can call sub-agents such as a similarity-scoring agent, filtering agent, or ranking agent to score candidate neighbors (e.g., based on embedding similarity, attribute matches, authority level, recency, or user-specified constraints) and to select the next traversal frontier.

S400 can include selecting a set of related entities, generating summaries or reduced representations from information of the related entities (e.g., section-level summaries, attribute-level snippets, relationship summaries, etc.), evaluating whether one or more stop conditions are satisfied (e.g., based on the summaries, traversal history, query requirements, etc.), stopping traversal and information gathering when the stop condition is met, and repeating related entity identification, information retrieval, and summary generation when the stop conditions are not satisfied, wherein the related entities are neighboring entities to the set of (an illustrative example is given in FIG. 8). In a specific example, the traversal agent can maintain an evolving working set of entities and summaries, and iteratively refine this working set across successive iterations until a stop condition is met.

For example, the method can include iteratively: identifying existing entities in the SOKG related to the query, retrieving the information for the identified entities (e.g., semantics, reasoning, attributes, relationships etc.), analyzing the retrieved information (e.g., generating a response to the query based on the retrieved information), evaluating whether a stop condition has been met, returning the response when the stop condition has been met, and determining additional entities related to the identified entities when the stop condition has not been met.

S400 can be performed once, multiple times, continuously, periodically, iteratively, and/or at any other suitable frequency. For single-shot interactive queries, S400 can be performed once from an initial entity set to generate a one-time response for the user. For iterative workflows, S400 can be repeated multiple times in response to follow-up questions, clarifications, or refined constraints, optionally reusing prior traversal state (e.g., already-visited entities and relationship scores).

However, traversing the self-organizing knowledge graph based on the query S400 may be otherwise performed.

In variants, S400 can include: identifying a set of response entities S420; extracting relevant information from the identified entities S440; and evaluating whether a stop condition is met S480; but can be otherwise performed.

Identifying a set of response entities S420 functions to determine a relevant entity within the SOKG. S420 can be performed in response to query receipt, continuously, periodically, and/or any other suitable timing. The response entity set can include one or more entities from the SOKG and/or other entities. The response entity set can be determined from: all entities, only public entities, public entities and entities associated with the querying user, entities that satisfy a rule, filter, or other constraint (e.g., entities within a predetermined timeframe, entities from a predetermined jurisdiction, entities with a predetermined precedential state, etc.), and/or any other set of constrained entities. In examples, the response entity set for public or private entities can be restricted to entities having classifications or roles (e.g., statutes, regulations, administrative rulings, binding case law, internal memos), entities with a minimum authority level, entities marked as controlling for a given topic or taxpayer profile, and/or be otherwise restricted. The response entity set can alternatively be unrestricted.

The entities in the response entity set are preferably related to the query, but can alternatively be unrelated to the query. Entities related to the query can be identified in a similar manner to S240, but can alternatively be otherwise determined. In an example, the existing entity can be related to the query by one or more of: a stated relationship, shared set of attribute values, shared semantics, and/or other shared pieces of information.

In variants, identifying a set of response entities S420 includes adding an initial set of entities related to the query in the response entity set; and iteratively adding additional entities related to the previously-identified entities to the response entity set until a stop condition is met.

Adding an initial set of entities related to the query in the response entity set functions to provide a seed set of entities for analysis. The initial set of entities can be determined based on a set of initial constraints, based on a relationship with the query, and/or otherwise identified. The initial constraints can be specified by the user, extracted or inferred from the query, be related to the query (e.g., by an explicit relationship or reference, share attribute values with the query, be semantically similar to the query, be embedded adjacent the query in a latent space, etc.), be a default set of initial constraints, and/or any other suitable constraint specification method. In an example, only entities within a predetermined timeframe are considered for inclusion in the initial entity set.

The initial seed entity set can include entities whose attribute values are similar to or match query attributes (e.g., jurisdiction, tax year, entity type, etc.), entities that are semantically similar to the query based on embedding similarity or other semantic measures, entities selected based on date or temporal criteria (e.g., most recent authorities within a specified window), entities explicitly mentioned or referenced in the query (e.g., specific code sections, case names, form numbers), entities explicitly specified by the user or calling workflow (e.g., a watchlist, a user-pinned authority, or a prior result set), and/or any other initial seed entity.

S400 can generate one or more initial entity sets. Different initial entity sets can differ in how they were constructed (e.g., which attribute types are shared with the query, the rule used to construct the set, etc.), or otherwise differ.

In a first variant, the response entity set can be determined based on a similarity score between the query embedding and the entities'embeddings (e.g., wherein the entities with similarity scores that satisfy a threshold can be used as the initial entity). Example similarity scores that can be used can include cosine similarity, Mahalanobis distance, Jaccard similarity, Hamming distance, Levenshtein distance, Euclidean distance, and/or any other suitable similarity scores.

In a second variant, the response entity set can be determined using a search algorithm, such as approximate nearest neighbors (ANN), and/or any other suitable search algorithm.

In a third variant, the response entity set can be determined based on a similarity between the query (and/or query attributes) and the attributes (or attribute set) of each entity. In a first example of the third variant, the response entity set can be determined by first identifying entities whose attribute values satisfy a similarity condition with respect to a query attribute set (e.g., matching jurisdiction, tax year, issue type, referenced entity identifier, etc.) and based on a semantic embedding similarity, thereby applying attribute-value similarity and embedding-based semantic similarity as distinct similarity criteria. In a second example of the third variant, the response entity set can be based on a similarity score between the query embedding and embeddings of each entity's attributes. In a third example of the third variant, the response entity set can be based on rules, range matching, pattern matching, hash matching, cluster assignment (e.g., wherein the entities are clustered, and the query is assigned to the cluster), and/or any other matching methods. In a fourth example of the third variant, the response entity set can be determined by calculating a percentage of matched attributes between the query and each entity (e.g., wherein the matching percentage and/or whether the attribute matches can be determined by a ML model, etc.), wherein entities with higher than a threshold match can be included in the response entity set.

In a fourth variant, S420 can include manually specifying the response entity set.

In a fifth variant, S420 can include any combination of variations. In an example of the fifth variant, a candidate primary entity set can be identified using the first variant, and filtered using the second variant (e.g., wherein recent candidate primary entities issued within a predetermined timeframe are retained; wherein candidate primary entities with a “valid” validity status are retained, etc.), and/or any other suitable combination of variations.

However, adding an initial set of entities related to the query in the response entity set may be otherwise performed.

Iteratively adding additional entities related to the previously-identified entities to the response entity set functions to augment the initial entity set with additional entities that may be relevant to the query. Additional entities can be added until a stop condition is met (e.g., in S480), and/or until any other condition is met.

The additional entities (secondary entities) can be related to a previously-identified entity by an explicit relationship (e.g., stored by the previously-identified entity, stored by the additional entity, etc.); by a shared or similar attribute value (e.g., with a cosine similarity lower than a threshold, etc.); by shared semantics; by topical similarity; data relationships; contextual relationships; hierarchical relationships; and/or be otherwise related to the previously-identified entity. The relationship parameter used to identify additional entities can be predetermined (e.g., manually specified, defined by a rule, etc.), be determined by a model (e.g., a query response generation model, etc.), and/or otherwise determined. The relationship parameter can be predetermined (e.g., default), determined based on the query (e.g., predicted based on the query), and/or any other suitable determination method.

In a first example, only related entities with positive treatment by the identified entity are identified.

In a second example, only related entities whose most recent relationship is associated with positive treatment are identified.

Adding additional entities to the response entity set can include identifying subsequent entities related to one or more previously identified entities (e.g., based on explicit relationships, implicit relationships, and/or other relationships defined in the SOKG). The subsequent entities can optionally be deemed relevant when the respective entity is also related to the query, or when other conditions are met.

The secondary entities can include: all entities related to an identified entity, related entities with similarity to the query higher than a threshold, related entities associated with a subset of relationship classifications, related entities associated with a predetermined set of attributes, related entities selected by an ML-based exploration agent, and/or any other entities.

The relevance of the connected entities can be determined based on the query context, query parameters, query requirements, and/or any other suitable factors. The relevance of the additional entities can be determined in a similar manner as discussed above for related entities (e.g., based on a rule set, predicted by a model, determined based on a similarity score, etc.), or be determined using path finding (e.g., shortest path, k-hops, constrained walks, graph constrained reasoning, constraint satisfaction, graph-guided tool calling (e.g., the LLM decides which entities to inspect, which relationships to follow, when to stop, etc.), otherwise determined).

Additional entities can be identified before stop condition analysis, after stop condition analysis, and/or at any other time. Additional entities can be identified before query response generation, after a prior query response generation, and/or at any other time. Additional entities are preferably identified after the initial set of entities are identified, but can alternatively be identified at any other time. Additional entities are preferably iteratively identified until a stop condition is met, but can alternatively be performed in any other suitable manner.

In an example, secondary entities connected to the previously-identified entities can be iteratively identified until the stop condition is met, and/or any other suitable entities can be identified in any other suitable manner.

The predetermined set of attributes used for additional entity identification can be determined manually, based on the query (e.g., by extracting attributes from the query, predicting attributes that would be relevant to the query, etc.), and/or using any other suitable determination method. In an example, only related entities that are newer than the identified identity are identified.

The exploration agent can determine the next (second) entity's relevance based on the query and the relationship description between the prior entity and the next (secondary) entity, the next entity's data (e.g., raw data, embeddings, attribute set, etc.), and/or other information. In an example, an agent (e.g., LLM) parses the relationships for the identified entity in light of the query and decides which entities should be explored next. In a specific example, the agent (e.g., LLM) is provided a query, a list of neighboring documents, their relationship to the current document, and their attributes, and returns a list of the neighboring documents that should be analyzed.

However, iteratively adding additional entities related to the previously-identified entities to the response entity set until a stop condition is met may be otherwise performed.

However, identifying a set of response entities S420 may be otherwise performed.

Extracting relevant information from the identified entities S440 functions to identify a subset of information for response generation. S440 can be performed after all relevant entities are identified (e.g., after multiple iterations of identifying additional entities for inclusion in the response entity set), be performed each time a relevant entity is identified (e.g., at each iteration), and/or at any other suitable time (e.g., example shown in FIG. 3). In a first example, entity information is aggregated from the identified entities as they are identified (e.g., as they are added to the relevance entity set). In a second example, entity information is aggregated from the identified entities in the relevance entity set after the stop condition is met.

S440 can be independently repeated for each relevant entity, performed for the relevant entity set as a whole, and/or any other suitable processing approach.

The relevant information can be weighted based on the relationships associated with the identified entity (e.g., lower weight if a controlling entity has overturned the identified entity, higher weight if the identified entity has been upheld multiple times, etc.), and/or any other suitable weighting factors.

The relevant information can be determined based on data for the set of identified entities (e.g., raw document, embeddings, attributes, etc.), prior responses to the query (e.g., generated from prior iterations of all or portions of S400), and/or any other suitable determination bases.

The aggregated information can be stored in temporary memory, working memory, or otherwise stored.

The aggregated information can include: all information from the response entities in the response entity set, a subset of information from the response entities (e.g., certain pieces of information, etc.), and/or any other information. The aggregated information can be used as a repository or reference for query response generation (e.g., using RAG, etc.), summarized into the response, or otherwise used.

The subset of information extracted from the entities can be: manually determined, determined based on the query, determined by a response agent (e.g., wherein the response agent selects the type of information needed to generate the query response, then generates the response from the selected information type), and/or otherwise determined.

In a first example, the types of information parameters that are aggregated can be determined by a model (e.g., agent) based on the query. For example, relationships can be retrieved for a first query, while semantic content can be retrieved for a second query.

In a second example, the types of information parameters that are aggregated are specified by the query. For example, any changes to the entity information made within a predetermined time period (e.g., last week, last month, etc.) can be aggregated into a summary or dashboard.

S440 can additionally or alternatively include generating a query response from the relevant information.

The query response is preferably generated using a model (e.g., agent), wherein the query and the relevant information is passed to the model, but can additionally or alternatively be otherwise generated. The response can be generated using: RAG (retrieval augmented generation), a Q&A method (e.g., using BERT, etc.), using parametric approaches (e.g., by finetuning a model), using index-free or structure-first approaches, using programmatic querying (e.g., wherein the corpus is transformed into a structured database that is subsequently traversed), using key-value memory models, using corpus-driven decoding, and/or using other methods.

The query response can be generated using one or more models. In an example, multiple models generate candidate responses, wherein a final response is selected from the candidate responses (e.g., based on a confidence score, alignment with the query, etc.). However, a single response can be generated from the aggregated corpus for the query.

In a first variant, S440 can include passing data for the set of identified entities (e.g., raw document, embeddings, attributes, etc.), most relevant sections, or entity summary and query to an agent (e.g., ML model, large model, etc.); and prompting the agent to answer the query based on the entity. The relevant sections can be identified using an embedding-based similarity score with the query, by identifying the source of the entity attributes relevant to the query, by identifying sections associated with a predetermined set of tags, and/or any other suitable identification method.

In a second variant, S440 can include using a Q&A model (e.g., BERT) to answer the query against the relevant entity set, and/or any other suitable information extraction method.

However, extracting relevant information from the identified entities S440 may be otherwise performed.

Evaluating whether a stop condition is met S480 functions to conditionally stop all or portions of S400 when stop conditions are met. The stop condition can be evaluated at every iteration of S420, every iteration of S440, every N iterations of S420, after a predetermined amount of time has passed, when an evaluation condition is met, after query result generation (e.g., after S500), and/or any other suitable evaluation timing. Examples are shown in FIG. 3, FIG. 8, and FIG. 9.

In variants, evaluation of the stop condition can be delegated to a dedicated stop-condition agent that inspects the evolving response, the set of traversed entities, and/or task-specific rules to decide whether traversal should continue or terminate.

Stop conditions can include depth constraints (e.g., maximum number of hops from the initial entity set), hop counts, elapsed time limits, maximum numbers of visited entities or relationships, convergence condition satisfaction (e.g., the same entities are retrieved across successive iterations), heuristic satisfaction, other resource or cost limit satisfaction, and/or satisfaction of any other stop condition. Stop conditions can additionally or alternatively include semantic criteria, such as a convergence condition for a running summary, a lack of substantial change in the set of candidate answers over successive iterations, or a relevance or confidence score exceeding a threshold.

In a first example, the stop condition can be satisfaction of a predetermined depth limit. In an illustrative example, recursion stops at a predetermined depth (e.g., number of entity degrees out from an initial entity, curr_depth>=max_depth, etc.).

In a second example, the stop condition can be a confidence score of the response (e.g., generated in S440) and/or confidence that the response answers the query satisfying a confidence threshold.

In a third example, the stop condition can be satisfaction of a predetermined time duration.

In a fourth example, the stop condition can be satisfaction of a predetermined number of entities that have been traversed and/or reviewed.

In a fifth example, the stop condition can be when a result (e.g., generated from the aggregated relevant information) changes below a threshold amount (e.g., similarity score between the current result and the prior result is above a threshold), and/or any other suitable stop condition.

In a sixth example, the stop condition can include a confidence score associated with the result exceeding a threshold value.

In a seventh example, the evaluation can include evaluating whether a response generated from entity information aggregated from entities in the response entity set would satisfy the query in response to adding a new entity to the response entity set.

In an eighth example, the evaluation can include adding entities to the response entity set until a heuristic (e.g., number of entities, number of iterations, etc.) is met.

In a ninth example, a dedicated stop-condition agent can inspect the current traversal history, a draft response generated from information aggregated from the current traversal history, and task configuration (e.g., “shallow and fast” versus “deep and exhaustive”) and decide whether traversal should continue, pause, or terminate.

However, evaluating whether a stop condition is met S480 may be otherwise performed.

Providing query results S500 functions to return results to the user. The query results can include the response (e.g., generated in S440), the identified relevant entities (e.g., identifiers, raw documents, URIs to the entities, etc.), relevant sections of identified entities, summaries generated in S440, reasoning generated in S440, and/or any other suitable query results. An example is shown in FIG. 9. The query results can be provided as the relevant entities are being identified, as the summaries are being generated, after the stop condition is met, and/or at any other suitable time point.

The providing query results S500 can include generating query results and returning the query results to the user.

In a first variant, the query results can be predicted by a result agent based on the aggregated information (e.g., from S420, S440). In a first example, the query results can be predicted based on the aggregated information using RAG. In a second example, the query results can be predicted by summarizing the aggregated information (e.g., using parametric capabilities of the agent). However, the query results can be otherwise predicted.

In a second variant, query results can be selected from the aggregated information (e.g., based on confidence score, similarity score to the query, etc.).

In a third variant, query results can include the response entity and/or information thereof.

In a fourth variant, the response entity set and/or aggregated can be used for knowledge-graph augmented decoding, knowledge-graph derived intermediate representations, knowledge graph-based explanation generation, knowledge graph driven aggregation and synthesis, knowledge-graph driven search, and/or otherwise generated.

The query results to the user can be returned on a dashboard, user interface, an API, and/or otherwise returned.

In a first example, the relevant entities can be presented in order of relevance (e.g., highest similarity score, etc.), and/or any other suitable presentation order.

In a second example, the relevant entities can be presented with filters (e.g., by case date, court level, legal principle) to refine and narrow down relevant entities, and/or any other suitable presentation methods.

In a third example, the section(s) within relevant entities that directly answer/address the query can be listed and highlighted, and/or any other suitable presentation method can be used.

In some variants, the query results UI can present an interactive graph view in which entities and relationships identified by the agents can be browsed, filtered, and/or expanded, so that updates to the SOKG directly change how the user navigates the knowledge graph.

However, providing query results S500 may be otherwise performed.

### SPECIFIC EXAMPLES

Specific Example 1. A method for information management, comprising: maintaining a self-organizing knowledge graph comprising a set of entities, wherein each entity is associated with a precedential status; extracting new entity information from a new entity; identifying an entity within the self-organizing knowledge graph related to the new entity; updating the precedential status of the identified entity based on the new entity information; and propagating updates through the self-organizing knowledge graph by iteratively: identifying a secondary entity related to previously identified entities related to the new entity within the self-organizing knowledge graph, and updating the precedential status of the secondary entities based on the precedential statuses of a set of intermediate entities relating the secondary entity and the new entity.

Specific Example 2. The method of Specific Example 1, wherein the precedential status of the secondary entity is updated based on the new entity information.

Specific Example 3. The method of Specific Example 2, wherein the precedential status of the secondary entity is updated when a confidence score associated with the precedential status of the secondary entity is higher than a confidence score associated with the new entity information.

Specific Example 4. The method of Specific Example 2, wherein the precedential status of the secondary entity is not extracted from the new entity.

Specific Example 5. The method of Specific Example 1, wherein the updated precedential statuses of the secondary entities are predicted using a generative model.

Specific Example 6. The method of Specific Example 1, wherein updating the precedential status for the identified entity comprises changing the precedential status from an overruled status to an affirmed status based on positive treatment of the identified entity by the new entity.

Specific Example 7. The method of Specific Example 1, wherein the updated precedential status of the identified entity further comprises a natural language reason statement for the updated precedential status.

Specific Example 8. The method of Specific Example 7, further comprising generating a query response to a user query using the precedential status of the identified entity and the natural language reason statement.

Specific Example 9. The method of Specific Example 8, wherein generating the query response comprises: iteratively aggregating entity information from entities within the self-organizing knowledge graph related to the user query; and predicting the query response from the aggregated entity information using a generative model.

Specific Example 10. The method of Specific Example 1, wherein the new entity information is extracted without using a human-defined ontology.

Specific Example 11. A method, comprising: maintaining a self-organizing knowledge graph comprising a set of implicitly related entities, wherein each entity is associated with an entity information set; receiving a user query; extracting a query information set from the user query without using a predefined ontology; identifying a set of response entities related to the query from the set of implicitly related entities using a traversal agent based on the query information set and the respective entity information sets; aggregating information from the respective entity information sets from the set of response entities; and predicting a response to the user query based on the aggregated information using a response agent.

Specific Example 12. The method of Specific Example 11, wherein the traversal agent and the response agent comprise generative models.

Specific Example 13. The method of Specific Example 11, wherein the entity information sets are extracted from the respective entities without using a predefined ontology.

Specific Example 14. The method of Specific Example 11, wherein in response to new entity receipt, new information extracted from the new entities is propagated through the self-organizing knowledge graph by updating the entity information sets of entities, related to the new entity, within the set of implicitly related entities based on the new information.

Specific Example 15. The method of Specific Example 14, wherein the updated entity information sets are predicted by a generative model.

Specific Example 16. The method of Specific Example 11, wherein the entity information sets each comprise a set of attribute values and reasoning for the respective attribute value, wherein the response is predicted based on the reasoning.

Specific Example 17. The method of Specific Example 11, wherein the entity information sets each comprise a precedential status for the respective entity, wherein the response is predicted based on the precedential status.

Specific Example 18. The method of Specific Example 17, wherein the precedential status for an entity is updated based on new information extracted from a new entity when a confidence score for the new information is lower than a confidence score for the precedential status for the entity.

Specific Example 19. The method of Specific Example 11, wherein identifying the set of response entities, aggregating information from the set of response entities, and predicting the response is iteratively performed until a stop condition is met.

Specific Example 20. The method of Specific Example 19, wherein each entity information set comprises a set of attribute values and a set of semantics for the respective entity, wherein the set of response entities related to the query are identified based on similarities between the set of attribute values for the response entity and a set of attribute values extracted from the query.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures. However, unbroken lines in the figures should not be interpreted to indicate that the depicted elements are essential, nor to indicate that the depicted elements may not be omitted from variants of the invention.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

1. A method for information management, comprising:
maintaining a self-organizing knowledge graph comprising a set of entities, wherein each entity is associated with a precedential status;
extracting new entity information from a new entity;
identifying an entity within the self-organizing knowledge graph related to the new entity;
updating the precedential status of the identified entity based on the new entity information; and
propagating updates through the self-organizing knowledge graph by iteratively:
identifying a secondary entity related to previously identified entities related to the new entity within the self-organizing knowledge graph; and
updating the precedential status of the secondary entities based on the precedential statuses of a set of intermediate entities relating the secondary entity and the new entity.

2. The method of claim 1, wherein the precedential status of the secondary entity is updated based on the new entity information.

3. The method of claim 2, wherein the precedential status of the secondary entity is updated when a confidence score associated with the precedential status of the secondary entity is higher than a confidence score associated with the new entity information.

4. The method of claim 2, wherein the precedential status of the secondary entity is not extracted from the new entity.

5. The method of claim 1, wherein the updated precedential statuses of the secondary entities are predicted using a generative model.

6. The method of claim 1, wherein updating the precedential status for the identified entity comprises changing the precedential status from an overruled status to an affirmed status based on positive treatment of the identified entity by the new entity.

7. The method of claim 1, wherein the updated precedential status of the identified entity further comprises a natural language reason statement for the updated precedential status.

8. The method of claim 7, further comprising generating a query response to a user query using the precedential status of the identified entity and the natural language reason statement.

9. The method of claim 8, wherein generating the query response comprises:
iteratively aggregating entity information from entities within the self-organizing knowledge graph related to the user query; and
predicting the query response from the aggregated entity information using a generative model.

10. The method of claim 1, wherein the new entity information is extracted without using a human-defined ontology.

11. A method, comprising:
maintaining a self-organizing knowledge graph comprising a set of implicitly related entities, wherein each entity is associated with an entity information set;
receiving a user query;
extracting a query information set from the user query without using a predefined ontology;
identifying a set of response entities related to the query from the set of implicitly related entities using a traversal agent based on the query information set and the respective entity information sets;
aggregating information from the respective entity information sets from the set of response entities; and
predicting a response to the user query based on the aggregated information using a response agent.

12. The method of claim 11, wherein the traversal agent and the response agent comprise generative models.

13. The method of claim 11, wherein the entity information sets are extracted from the respective entities without using a predefined ontology.

14. The method of claim 11, wherein in response to new entity receipt, new information extracted from the new entities is propagated through the self-organizing knowledge graph by updating the entity information sets of entities, related to the new entity, within the set of implicitly related entities based on the new information.

15. The method of claim 14, wherein the updated entity information sets are predicted by a generative model.

16. The method of claim 11, wherein the entity information sets each comprise a set of attribute values and reasoning for the respective attribute value, wherein the response is predicted based on the reasoning.

17. The method of claim 11, wherein the entity information sets each comprise a precedential status for the respective entity, wherein the response is predicted based on the precedential status.

18. The method of claim 17, wherein the precedential status for an entity is updated based on new information extracted from a new entity when a confidence score for the new information is lower than a confidence score for the precedential status for the entity.

19. The method of claim 11, wherein identifying the set of response entities, aggregating information from the set of response entities, and predicting the response is iteratively performed until a stop condition is met.

20. The method of claim 19, wherein each entity information set comprises a set of attribute values and a set of semantics for the respective entity, wherein the set of response entities related to the query are identified based on similarities between the set of attribute values for the response entity and a set of attribute values extracted from the query.
